(19) United States
(12) Patent Application Publication
(10) Pub. No.: US 2010/0082480 A1
(43) Pub. Date: Apr. 1, 2010

(54) PAYMENTS WITH VIRTUAL VALUE

(76) Inventor: Jason Alexander Korosec, Morgan Hill, CA (US)

Correspondence Address: HAYNES AND BOONE, LLP;IP Section, 2323 Victory Avenue, Suite 700, Dallas, TX, 75219, US

(21) Appl. No.: 12/242,561

(22) Filed: Sep. 30, 2008

(51) Int. Cl. G06Q 40/00

(52) U.S. Cl. 705/40; 705/400

(57) ABSTRACT

Methods and systems for payments with virtual value are described. In one embodiment, a virtual value indication associated with a user from a virtual value provider may be received. Virtual value may be associated with a user account in response to receiving the virtual value indication. A payment request may be received. A portion of the virtual value associated with the account may be converted to a base value of a base value type at a conversion rate in response to the receiving of the payment request. The payment request may be processed for the account using the base value. Additional methods and systems are disclosed.

### BACKGROUND

A user may seek to purchase one or more items over a network. However, the user may not have enough funds available to make the purchase. The user may decide to forgo the purchase, or may borrow money to make the purchase.

### BRIEF DESCRIPTION OF THE DRAWINGS

Some embodiments are illustrated by way of example and not limitation in the figures of the accompanying drawings in which:

FIG. 1 is a block diagram of a system, according to an example embodiment;

FIG. 2 is a block diagram of a virtual value processing subsystem that may be deployed within the system of FIG. 1, according to an example embodiment;

FIG. 3 is a block diagram of a virtual value request processing subsystem that may be deployed within the system of FIG. 1, according to an example embodiment;

FIG. 4 is a block diagram of a payment request processing subsystem that may be deployed within the system of FIG. 1, according to an example embodiment;

FIG. 5 is a block diagram of a payment request processing subsystem that may be deployed within the system of FIG. 1, according to an example embodiment;

FIG. 6 is a block diagram of a virtual value subsystem that may be deployed within the system of FIG. 1, according to an example embodiment;

FIG. 7 is a block diagram of a listing subsystem that may be deployed within the system of FIG. 1, according to an example embodiment;

FIGS. 8-11 are flowcharts illustrating methods for payment request processing according to example embodiments;

FIG. 12 is a flowchart illustrating a method for usage request processing according to an example embodiment;

FIG. 13 is a flowchart illustrating a method for virtual value processing, according to an example embodiment;

FIGS. 14-20 are flowcharts illustrating methods for payment request processing, according to example embodiments;

FIG. 21 is a diagram of a converted value report, according to an example embodiment;

FIG. 22 is a diagram of a user interface, according to an example embodiment;

FIGS. 23-27 are flowcharts illustrating method for item listing, according to example embodiments;

FIG. 28 is a diagram of a user interface, according to an example embodiment;

FIG. 29 is a network diagram depicting a network system, according to an example embodiment, having a client server architecture configured for exchanging data over a network;

FIG. 30 is a block diagram illustrating an example embodiment of multiple network and marketplace applications, which are provided as part of a network-based marketplace; and

FIG. 31 is a block diagram of a machine in the example form of a computer system within which a set of instructions for causing the machine to perform one or more of the methodologies discussed herein.

### DETAILED DESCRIPTION

Example methods and systems for payments with virtual value are described. In the following description, for purposes of explanation, numerous specific details are set forth in order to provide a thorough understanding of example embodiments. It will be evident, however, to one of ordinary skill in the art that embodiments of the invention may be practiced without these specific details.

Users may have more than one option for purchasing goods and services. For example, a user may make a purchase using cash, check, debit card, credit card, or PAYPAL payment service. The purchases may utilize a currency based value, such as US Dollars, British Pounds, or Euros, as the denomination of the purchase.

Yet, increasingly, consumers hold other accumulated sources that are not measured in a currency, including frequent flier miles, hotel reward points, rental car points, points for using credit cards, or other non-currency measures of value.

Consumers may want to utilize these other sources, instead of using currency based value, to make a purchase over the Internet, through an online auction, online or paper catalog, or in person at a physical brick-and-mortar merchant.

Without the ability to convert and use the non-currency based value associated with the other sources, a user may elect to forgo the purchase, creating a lost sales opportunity for a merchant or seller.

In an example embodiment, an acceptance network of merchants that enables the acceptance and in purchase conversion of frequent flyer miles, hotel reward points, and other forms of virtual value to traditional currency based value to facilitate payment is described. The acceptance network may also enable transferability of virtual value to facilitate payment or other usage when the rules of programs allow such transfers.

By way of an example, a user may visit a county fair and want to buy something that an artisan has created. The cost of the creation may be twenty dollars. By reviewing a user interface on a mobile phone, the user may tell the artisan that the user can pay the twenty dollars with a credit card, a debit card, or a bank account. The user may also perform a query using the user interface to determine the cost of the item in MARRIOTT REWARDS points. The artisan may advise the user on whether the MARRIOTT REWARDS points will be accepted or whether the user will need to first convert the MARRIOTT REWARDS points to dollars to make the purchase. If the artisan receives the points, the artisan may retain and later use the points or may convert the MARRIOTT REWARDS points to dollars.

The merchant or seller may list items for sale, lease, or other form of transfer in multiple types of real and virtual currencies. The value associated with the multiple types of real and virtual currencies need not match. For example, if the merchant or seller values frequent flyer miles over US dollars, the value of the amount of frequent flyer miles needed by a buyer to make the purchase may be less than a corresponding number of US dollars.

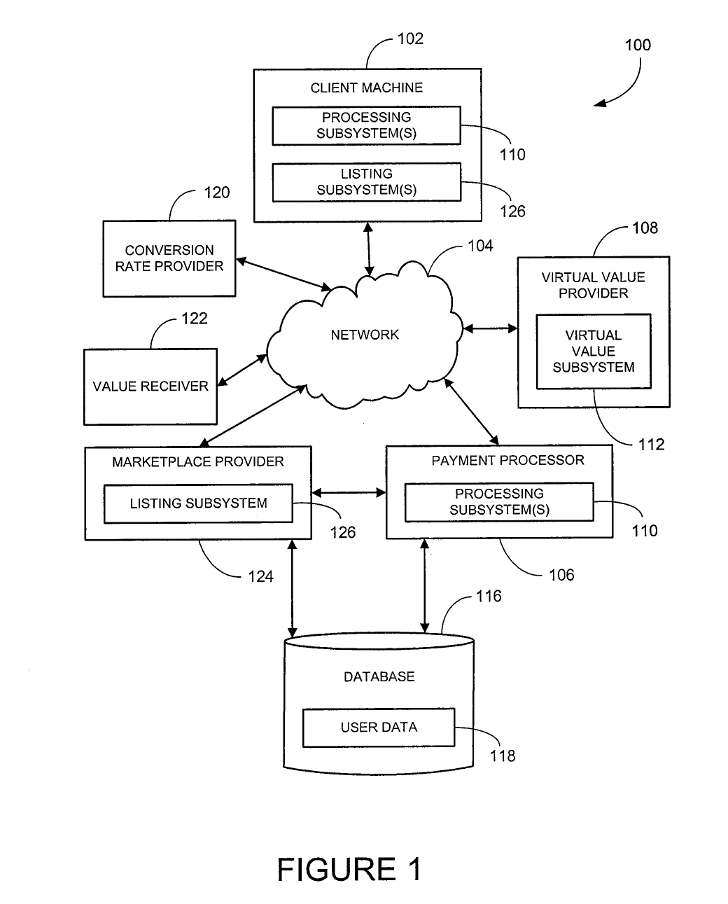

FIG. 1 illustrates an example system 100 in which a user may operate a client machine 102 to communicate over a network 104 with a payment processor 106 and/or a virtual value provider 108 to enable processing of payment requests using virtual value. The user may also operate the client machine 102 to communicate with the payment processor 106, the virtual value provider 108, and/or a marketplace provider 124 to post a listing of one or more items available for purchase, lease or other disposition. Example users include a person, a group of people (e.g., a family), or an entity (e.g., a company). Examples of the client machine 102 include a set-top box, a gaming unit, a receiver card, a mobile phone, a personal digital assistant (PDA), a display device, a kiosk, a point of sale (POS) device, a kiosk, a generic computing system, or the like. Other devices may also be used. Examples of set-top boxes may include DIRECTV receivers, DISH NETWORK receivers, TIME WARNER CABLE TV boxes, and other similar devices. Examples of gaming units may include a SONY PLAYSTATION, a MICROSOFT XBOX, a NINTENDO WII, and other similar devices.

The network 104 over which the client machine 102, the payment processor 106, the virtual value provider 108, and/or the marketplace provider 124 are in communication may include a Global System for Mobile Communications (GSM) network, an Internet Protocol (IP) network, a Wireless Application Protocol (WAP) network, a WiFi network, or an IEEE 802.11 standards network as well as various combinations thereof. Other conventional and/or later developed wired and wireless networks may also be used.

The payment processor 106 may have an acceptance network of merchants and other sellers that are willing to receive payment from the payment processor 106. The acceptance network of merchants and other sellers may be operated by the marketplace provider 124 or may be operated otherwise. For example, the payment processor 106 may be PayPal, Inc. of San Jose, Calif. and the acceptance network may be the merchants and other sellers of the marketplace provider 124, which may be eBay, Inc. of San Jose, Calif. However, other payments processors and/or acceptance networks may also be used. The user of the client machine 102 may use an e-mail address and password, a mobile telephone number and pin, a user id and a security token, or a different login mechanism to facilitate funds transfers and/or selections of items from the acceptance network for purchase.

The user may have one or more balance accounts with stored value and/or one or more access accounts that include access to value associated with a value provider (e.g., a bank or a credit card company). The value stored with the payment processor 106 may be real value (e.g., currency) and/or virtual value (e.g., non-currency). The value may be used to make a payment to a merchant or another type of seller in the form of a value receiver 122. The value receiver 122 may receive and have the received value in the format in which it is received and/or may convert the received value into a different format. The payment processor 106 may be capable of managing virtual value on behalf of a user.

Typically, the virtual value provider 108 does not provide virtual value to a user as a form of payment, but rather provides virtual value as an incentive for the user performing some action or purchase an item. Thus, the virtual value provider 108 may issue virtual value to a user based on one or more activities of the user and/or a status of the user with the virtual value provider 108. The activity may be performed with the virtual value provider 108, an affiliate of the virtual value provider 108, or a licensee of the virtual value provider 108. The virtual value provider 108 may be, by way of example, an airline reward program, a hotel reward program, a rental car reward program, a travel reward program, or the like. For example, the virtual value provider 108 may award 6,266 actual airline reward miles and 6,266 bonus airline reward miles to a user that is travelling between Tokyo, Japan and Chicago, Ill. and has a particular status with the virtual value provider 108. The virtual value provider 108 may award miles for taking a flight with a partner airline. The virtual value provider 108 may award miles for signing up for a branded credit card.

Virtual value may include travel reward points, frequent flyer miles, hotel reward points, a rental car points, merchant reward points, game points, loyalty program points, or the like. Examples of travel reward points include AMERICAN EXPRESS MEMBERSHIP REWARDS and CAPITAL ONE travel rewards. Examples of frequent flyer miles include AMERICAN AADVANTAGE frequent flyer miles, DELTA SKYMILES, UNITED Mileage Plus miles, SOUTHWEST RAPID REWARD CREDITS, NORTHWEST WORLDPERKS frequent flyer miles, and VIRGIN flying club miles. Examples of hotel reward points include MARRIOTT REWARDS points, HILTON HHONORS points, RADISSON GOLDPOINTS PLUS points, and STARWOOD PREFERRED GUEST points. Examples of rental card points include HERTZ #b 1 award points. Examples of store or merchant reward points include BEST BUY REWARD ZONE points and CIRCUIT CITY rewards. Examples of game points include MICROSOFT XBOX LIVE points, NINTENDO WII points and SONY PLAYSTATION points.

The virtual value may include company scrip, military scrip, town or region based scrip, charity based scrip, specie, game scrip, private scrip, virtual scrip, or the like.

In an example embodiment, virtual value may include quantities of gold, silver, oil, or other commodities. Virtual value may include stocks, bonds, and certificates of deposits (CDs.). Other types of virtual value may also be used.

The virtual value provider 108 may provide the virtual value associated with the user to the payment processor 106. The virtual value may be provided as part of an agreement between the virtual value provider 108 and the payment processor 106, at the request of a user, or may be otherwise provided.

The payment processor 106 may maintain the virtual value received on behalf of the user. For example, the virtual value provider 108 may provide 100,000 airline award miles associated with the user to the payment processor 106. The 100,000 airline award miles may then not be available to the user through the virtual value provider 108 but may instead be available to the user through the payment processor 106. The award miles may be available for use through both the virtual value provider 108 for services from that virtual value provider (e.g., a free airline ticket in exchange for airline award miles) and/or through an acceptance network maintained by the payment processor 106 (e.g., products sold by sellers or merchants of the marketplace provider 124.

When used for payment, the payment processor 106 may transfer the virtual value to the user account of the value receiver 122 or may convert the virtual value to real value and provide the real value to the user account of the value receiver 122. The payment processor 106 may charge one or more fees for the conversion and/or the transfer.

A settlement account may be maintained with the payment processor 106 by the virtual value provider 108, on behalf of the value receiver 122, a target user, and others. The settlement account may enable a receiver to receive funds in real value despite receiving virtual value. The payment processor 106 may convert the virtual value into real value on behalf of a source user and alter the real value for a target user and a settlement account accordingly. For example, if a source user provides 10,000 airline miles as payment for an item, a target user account may be increased by one hundred dollars based on the value of the received airline miles. The one hundred dollars may be decreased from a settlement account associated with the virtual value provider 108 to reflect that the 10,000 airline miles are no longer available for redemption by the source user.

The settlement account may hold a positive or negative value. If the settlement account holds a negative value, in effect, the payment processor 106 may be lending real value to the virtual value provider 108 and/or the value receiver 122. When a transfer of virtual value would result in a negative settlement account, the payment processor 106 may make a policy decision (e.g., involving all standard risk issues associated with lending generally) to determine whether the transfer will be allowed.

The virtual value provider 108 may be capable of determining whether a virtual value payment request meets a compliance criterion. The compliance criterion may be defined and maintained by the virtual value provider 108. The criterion may include a funding source rule, a balance rule, a virtual value transferability rule, a payment processor rule, or the like. For example, the virtual value provider 108 may institute a rule that prohibits one user from transferring their virtual value to another user, except to an authorized value receiver. In which case, the payment processor 106 would only permit transfers to the value receivers 122 that have been authorized by the virtual value provider 108.

The virtual value provider 108 and the payment processor 106 may be operated or otherwise controlled by a single entity. For example, the payment processor 106 may issue proprietary or preexisting virtual value. Likewise, the virtual value provider 108 may incorporate payment processing functionality of the payment processor 106.

One or more processing subsystems 110 may be deployed in the client machine 102 and/or the payment processor 106 to process value utilization requests including payment requests. A virtual value subsystem 112 may be deployed in the virtual value provider 108 to receive a virtual value payment processing request from the payment processor 106 and alter the virtual value in a user account of the virtual value provider 108 by a virtual value amount.

The client machine 102, the payment processor 106 and/or the marketplace provider 124 may be in communication with a database 116. The database may include user data 118 regarding users of the payment processor 106 and/or the marketplace provider 124. For example, the user data 118 may include data on the virtual value accounts and corresponding virtual value amounts of the users of the payment processor 106

A conversion rate provider 120 may be in communication over the network 104 with the client machine 102 and/or the payment processor 106. The conversion rate provider 120 may obtain a conversion rate and/or obtain an updated conversion rate for one or more virtual value types. The conversion rate may be used to convert the virtual value to a real value. For example, a specified number of frequent flier miles may be converted to a certain number of dollars. The conversion rate between a virtual value and a real value, provided by the conversion rate provider 120, may enable the payment processor 106 to determine the amount to deduct from the settlement account of the virtual value provider 108, when moving real value to the value receiver 122. The payment processor 106 may contract with, own, manage, maintain, or otherwise engage with the conversion rate provider 120.

The value receiver 122 may be in communication over the network 104 with the client machine 102 and/or the payment processor 106. The value receiver 122 may be a person or entity that receives value from a user of the client machine. For example, the value receiver 122 may receive virtual value from the user of the client machine 102 in exchange for an item. The value receiver 122 may be identified in a virtual value usage request received from the user.

In an example embodiment, offering use of virtual value for fulfilling payment and other usage requests may enable the virtual value provider 108 to offer a wide variety of redemption opportunities to users while minimizing time spent entering into redemption relationships with one or more of the marketplace providers 124, the value receivers 122, and/or the payment processors 106.

In an example embodiment, offering use of virtual value for fulfilling payment and other usage requests may enable the virtual value provider 108 to reduce a balance of virtual value associated with user accounts. The reduction of the balance may enable the virtual value provider 108 to improve its balance sheet by reducing its liabilities. Without an expanded acceptance network enabled by the payment processor 106, in conjunction with conversion rate provider(s) 120, the value receiver(s) 122, and the marketplace provider(s) 124, a user's ability to redeem virtual value for products and services may be limited to the offers of the virtual value provider 108. With fewer offers, users would redeem less virtual value, increasing the liability on the balance sheet of the virtual value provider 108.

The marketplace provider 124 may communicate with the client machine 102 and/or the payment processor 106 to provide a networked-based marketplace where items (e.g., goods and/or services) may be purchased, leased, transfer, or otherwise transferred from or to at least one user. The real or virtual value payments for the items may be processed by the payment processor 106.

The payment processor 106 and the marketplace provider 124 may be operated by the same entity or different entities. For example, the payment processor 106 and the marketplace provider 124 may be integrated into a single website or may be available through multiple websites.

The marketplace provider 124 and/or the client machine 102 may include a listing subsystem 126 to enable listing of items for in the networked-based marketplace. The listing subsystem 126 may include listings in one or more real values and/or virtual values.

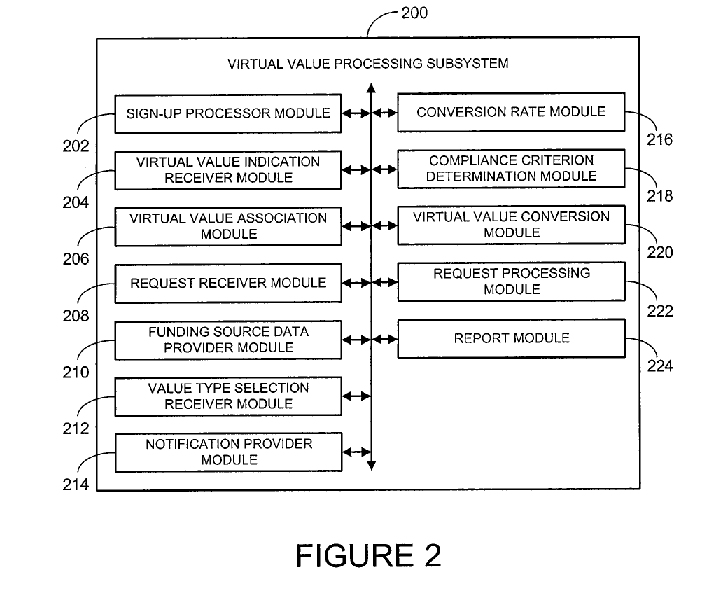

FIG. 2 illustrates an example virtual value processing subsystem 200 that may be deployed as the processing subsystem 110 in the client machine 102 and/or the payment processor 106 of the system 100 (see FIG. 1) or otherwise deployed in another system. The virtual value processing subsystem 200 may include a sign-up processor module 202, a virtual value indication receiver module 204, a virtual value association module 206, a request receiver module 208, a funding source data provider module 210, a value type selection receiver module 212, a notification provider module 214, a conversion rate module 216, a compliance criterion determination module 218, a virtual value conversion module 220, a request processing module 222, and/or a report module 224. Other modules may also be included. In various embodiments, the modules may be distributed so that some of the modules may be deployed in the client machine 102 and some of the modules may be deployed in the payment processor 106.

The sign-up processor module 202 processes a sign-up request for a user. Once processed by the sign-up processor module 202, the user will be enabled or ready to draw upon or redeem the virtual value, held by the virtual value provider 108, as processed by the payment processor 106. The user may then consume items offered on the marketplace provider 124, by providing the value receiver 122 with an equivalent amount of real value as converted by the conversion rate provider 120.

The virtual value indication receiver module 204 receives a virtual value indication from the virtual value provider 108. The virtual value indication may indicate an amount of virtual value associated with the user at the virtual value provider 108, or may include the amount of virtual value associated with the user account at the virtual value provider.

The virtual value association module 206 associates virtual value with an account of a user in response to the receiving of the virtual value indication. The request receiver module 208 receives a payment request. The funding source data provider module 210 provides funding source data identifying value types having value in an account of a user.

The value type selection receiver module 212 receives a value type selection of a virtual value type of the available value types and/or receives an additional value type selection of a value type of the available value types. The notification provider module 214 provides a notification regarding availability to use the virtual value (or a portion of the virtual value) to fulfill the payment request and/or provides a notification based on processing a payment request by the request processing module 222

The conversion rate module 216 receives a conversion rate from the virtual value provider 108, updates the conversion rate to obtain an updated conversion rate, and/or determines whether a conversion criterion is met and sets the conversion rate based on a result of the determination of whether the user meets the conversion criterion. The conversion criterion may be based on a virtual value threshold, a program entry date of the user, an amount of a payment request, an item associated with the payment request, or the like. Either a single conversion criterion or multiple conversion criteria may be used.

The compliance criterion determination module 218 determines whether a payment request meets a compliance criterion associated with the virtual value provider 108.

The virtual value conversion module 220 converts a portion of virtual value associated with an account to a base value of a base value type at a conversion rate in response to receipt of a payment request by the request receiver module 208. The conversion of the portion may be at an updated conversion rate and/or for an additional value type selection. The conversion of the portion may be further based on a determination that the payment request meets a compliance criterion.

The request processing module 222 processes the payment request for an account using a base value. The processing of the payment request may be based on a determination that the payment request meets the compliance criterion.

The report module 224 generates a converted value report. The generation of the converted value report may be based on an item value of an item associated with the payment request, a virtual value purchase cost, item historical value exchange data for the item, or the like.

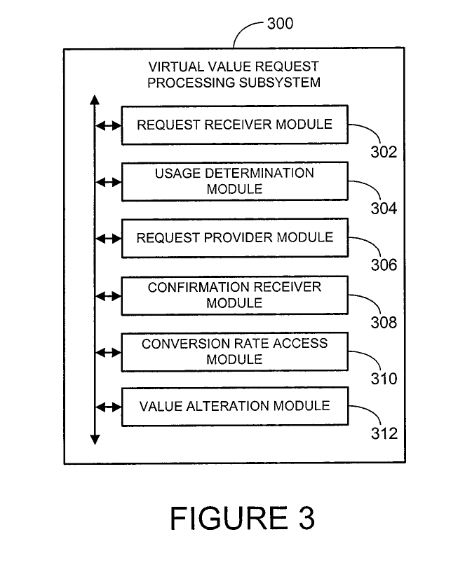

FIG. 3 illustrates an example virtual value request processing subsystem 300 that may be deployed as the processing subsystem 110 in the client machine 102 and/or the payment processor 106 of the system 100 (see FIG. 1) or otherwise deployed in another system. The virtual value request processing subsystem 300 may include a request receiver module 302, a usage determination module 304, a request provider module 306, a confirmation receiver module 308, a conversion rate access module 310, and/or a value alteration module 312. Other modules may also be included. In various embodiments, the modules may be distributed so that some of the modules may be deployed in the client machine 102 and some of the modules may be deployed in the payment processor 106.

The request receiver module 302 receives a virtual value usage request associated with a user. The virtual value usage request may include a virtual value amount of a virtual value type. The value receiver 122 may be identified in the virtual value usage request.

The usage determination module 304 determines whether virtual value usage is available for a user. The request provider module 306 provides a virtual value processing request to the virtual value provider 108. The providing of the virtual value processing request may be based on a determination that virtual value usage is available for a user.

The confirmation receiver module 308 receives value confirmation from the virtual value provider 108. The conversion rate access module 310 accesses a conversion rate for a virtual value type.

The value alteration module 312 alters value in a settlement account of the virtual value provider 108, alters value in a user account associated with a user, and/or alters the value in a value receiver account associated with the value receiver 122. The alteration of the value in the settlement account may be based on a virtual value amount and a conversion rate. The alteration of value in the user account may be based on the virtual value amount and the conversion rate. The alteration of value in a value receiver account may be based on the virtual value amount and the conversion rate. The alteration of the value may be in response to receipt of a value confirmation.

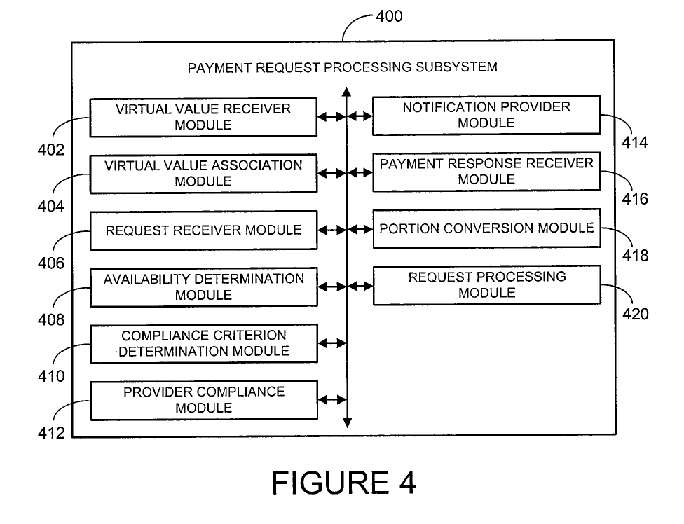

FIG. 4 illustrates an example payment request processing subsystem 400 that may be deployed as the processing subsystem 110 in the client machine 102 and/or the payment processor 106 of the system 100 (see FIG. 1) or otherwise deployed in another system. The payment request processing subsystem 400 may include a virtual value receiver module 402, a virtual value association module 404, a request receiver module 406, an availability determination module 408, a compliance criterion determination module 410, a provider compliance module 412, a notification provider module 414, a payment response receiver module 416, a portion conversion module 418, and/or a request processing module 420. Other modules may also be included. In various embodiments, the modules may be distributed so that some of the modules may be deployed in the client machine 102 and some of the modules may be deployed in the payment processor 106.

The virtual value receiver module 402 receives virtual value associated with a user from the virtual value provider 108. The virtual value association module 404 associates virtual value for a user account.

The request receiver module 406 receives a payment request associated with a user account. The availability determination module 408 determines whether virtual value is available to a user account.

The compliance criterion determination module 410 determines whether a payment request meets a compliance criterion associated with the virtual value provider 108.

The provider compliance module 412 provides a compliance request to the virtual value provider 108 and/or receives a compliance authorization from the virtual value provider 108 in response to providing the compliance request.

The notification provider module 414 provides a notification regarding availability of virtual value for a user account. The payment response receiver module 416 module receives a payment in response to a notification provided by the notification provider module 414.

The portion conversion module 418 converts a portion of the virtual value to a base value of a base value type at a conversion rate. The conversion of the portion may be based on receipt of a payment response, receipt of a compliance authorization, and/or on a determination that the payment request meets a compliance criterion. The request processing module 420 processes a payment request received by the request receiver module 406 for an account using a base value.

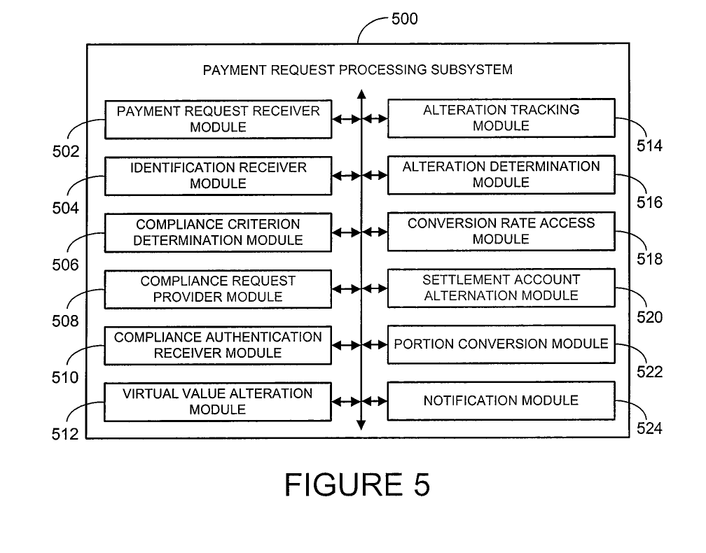

FIG. 5 illustrates an example payment request processing subsystem 500 that may be deployed as the processing subsystem 110 in the client machine 102 and/or the payment processor 106 of the system 100 (see FIG. 1) or otherwise deployed in another system. The payment request processing subsystem 500 may include a payment request receiver module 502, an identification receiver module 504, a compliance criterion determination module 506, a compliance request provider module 508, a compliance authentication receiver module 510, a virtual value alteration module 512, an alteration tracking module 514, an alteration determination module 516, a conversion rate access module 518, a settlement account alteration module 520, a portion conversion module 522, and/or a notification module 524. Other modules may also be included. In various embodiments, the modules may be distributed so that some of the modules may be deployed in the client machine 102 and some of the modules may be deployed in the payment processor 106.

The payment request receiver module 502 receives a virtual value payment request for a source user account and/or receives an additional virtual value payment request for the source user account. The virtual value payment request may include a payment amount. The additional virtual value payment request may include an additional payment amount.

The identification receiver module 504 receives identification of a target user account. The compliance criterion determination module 506 determines whether a virtual value payment request received by the payment request receiver module 502 meets a compliance criterion associated with the virtual value provider 108.

The compliance request provider module 508 provides a compliance request to the virtual value provider 108. The compliance authentication receiver module 510 receives a compliance authentication from the virtual value provider 108 in response to providing the compliance request by the compliance request provider module 508.

The virtual value alteration module 512 alters virtual value associated with a source user account based on the payment amount, alters virtual value associated with a target user account based on the payment amount, alters the virtual value associated with a payment processor account based on the payment amount, and/or alters the virtual value associated based on the additional payment amount. The alteration of the virtual value may be based on a determination that the payment request meets a compliance criterion, receipt of a compliance authentication, and/or receipt of identification.

The alteration tracking module 514 tracks altering of virtual value associated with a source user account and/or a target user account. The alteration determination module 516 determines a source user account may be altered by an additional payment amount based on a tracking of a source user account.

The conversion rate access module 518 accesses a conversion rate for virtual value based on a virtual value type of virtual value. The settlement account alteration module 520 alters a settlement account of a target user based on a payment amount and a conversion rate.

The portion conversion module 522 converts a portion of virtual value associated with the source user account in response to receipt of a virtual value payment request. The notification module 524 notifies the virtual value provider 108 of the alteration of virtual value associated with a target user account.

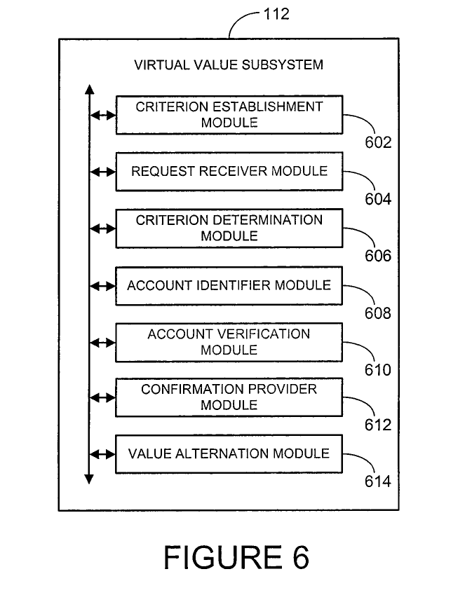

FIG. 6 illustrates an example virtual value subsystem 112 that may be deployed in the virtual value provider 108 of the system 100 (see FIG. 1) or otherwise deployed in another system. The virtual value subsystem 112 may include a criterion establishment module 602, a request receiver module 604, a criterion determination module 606, an account identifier module 608, an account verification module 610, a confirmation provider module 612, and/or a value alteration module 614. Other modules may also be included.

The criterion establishment module 602 establishes a compliance criterion for a virtual value payment processing request. The request receiver module 604 receives a virtual value payment processing request from the payment processor 106. The virtual value payment processing request may include a virtual value amount and an account identifier.

The criterion determination module 606 determines whether a compliance criterion is met for the virtual value payment processing request. The account identifier module 608 identifies a user account based on an account identifier.

The account verification module 610 verifies that a user account has virtual value in a virtual value amount. The confirmation provider module 612 provides a value confirmation to the payment processor 106 based on verification that the user account has virtual value in the virtual value amount.

The value alteration module 614 alters virtual value in a user account by a virtual value amount. The alteration of the virtual value may be based on a determination that a compliance criterion is met.

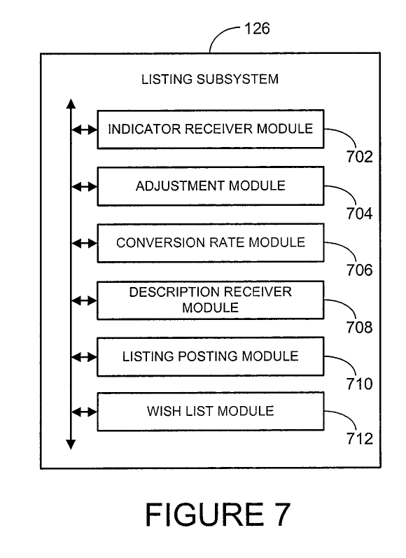

FIG. 7 illustrates an example listing subsystem 126 that may be deployed in the client machine 102 and/or the marketplace provider 124 of the system 100 (see FIG. 1) or otherwise deployed in another system. The listing subsystem 126 may include an indicator receiver module 702, an adjustment module 704, a conversion rate module 706, a description receiver module 708, a listing posting module 710, and/or a wish list module 712. Other modules may also be included. In various embodiments, the modules may be distributed so that some of the modules may be deployed in the client machine 102 and some of the modules may be deployed in the marketplace provider 124.

The indicator receiver module 702 receives an original pricing indicator of a base value type for the item and/or receives an alternate pricing indicator of the alternate value type for the item.

The adjustment module 704 adjusts the alternate pricing indicator by a marketplace fee to obtain the alternate value and/or accesses a value adjustment for the alternate value type and calculates the alternate price based on the original price and the value adjustment. The alternate pricing indicator may include the alternate price.

The conversion rate module 706 provides a conversion rate from the base value type to the alternate value type, receives a rate adjustment for the conversion rate, and/or adjusts the original price using the conversion rate and the rate adjustment to set the alternate price. The description receiver module 708 receives a description of an item.

The listing posting module 710 posts a listing for the item in a network-based marketplace, the listing including an original price of the base value type based on the original pricing indicator and an alternate price of an alternate value type. The original price may have a different value than the alternate price. The posting of the listing for the item in the network-based marketplace may include the description. The listing may include the alternate price of the alternate value type based on the alternate pricing indicator.

The wish list module 712 receives a selection on a wish list and determines the alternate price for the selection and/or receives a selection on a wish list, determines an available amount of alternate value, and calculates the alternate price based on an additional amount of the alternate value needed for the selection.

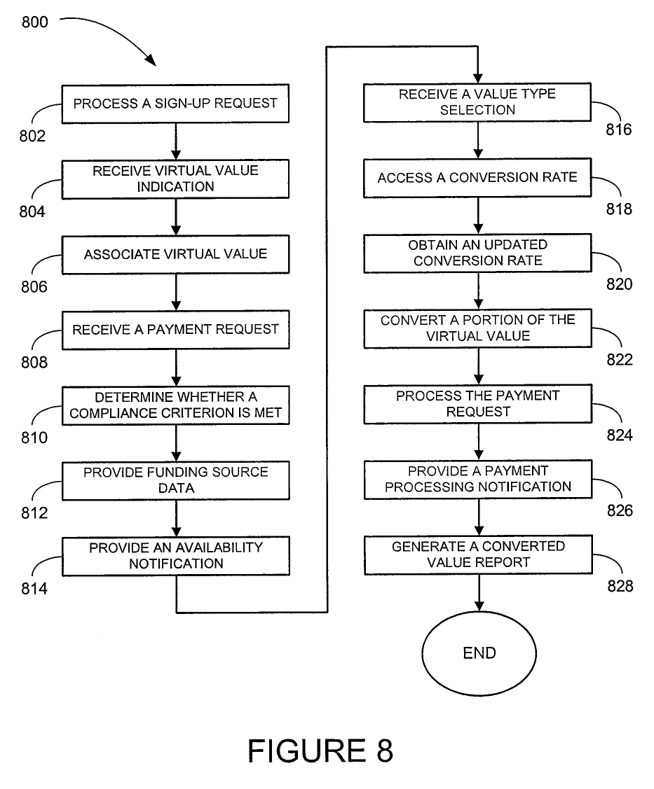

FIG. 8 illustrates a method 800 for payment request processing according to an example embodiment. The method 800 may be performed by the client machine 102 and/or the payment processor 106 of the system 100 (see FIG. 1) or otherwise performed.

The method 800 may be used to process a payment request using a portion of virtual value associated with a user account. For example, a certain amount of frequent flyer miles or other form of virtual value may be used to make a purchase instead of using US Dollars or other currency.

A sign-up request may be processed for the user at block 802. The sign-up request may enable the user to use virtual value to make payments and/or receive virtual value payments. The processing of the sign-up request may link a virtual value account of the virtual value provider 108 to an account with the payment processor 106 and/or provide (e.g., transfer) virtual value from the virtual value account to the account with the payment processor 106.

A virtual value indication associated with a user is received from the virtual value provider 108 at block 804. The virtual value indication may indicate virtual value or be virtual value. The virtual value may be a travel reward point, a frequent flyer mile, a hotel reward point, a rental car point, a merchant point, or the like. The virtual value may be gold, silver, oil, or other commodities, as measured in ounces or grams, gallons or liters, or another measure appropriate to the commodity. The virtual value may be a stock certificate, as measured in the value of that stock certificate. Other forms of virtual value may also be used.

In an example embodiment, the receipt of the virtual value indication from the virtual value provider 108 may make the virtual value unavailable to the user through the use of the virtual value provider 108. Rather, the virtual value may be available to the user through use of the payment processor 106.

The virtual value is associated with an account of the user at block 806. The amount of the virtual value associated may be based on the indication and/or received with the indication. The association of the virtual value may enable use of the virtual value with the payment processor 106 as opposed to the virtual value provider 108.

A payment request is received at block 808. The payment request may be to provide payment to the value receiver 122 in exchange for one or more items.

A determination of whether the payment request meets a compliance criterion associated with the virtual value provider may be made at block 810. The compliance criterion may include, by way of example, a funding source rule, a balance rule, a virtual value transferability rule, a payment processor rule, or the like. For example, the funding source rule may indicate that only a certain amount of virtual value may be received and/or used from a particular virtual value provider 108 during a period of time. The balance rule may limit the virtual value usage until a specific balance of virtual value is reached or may limit an amount (e.g., a percentage or a fixed amount) of virtual value usage of the virtual value available for a particular transaction or group of transactions. The virtual value transferability rule for a particular virtual value provider 108 may limit the amount of virtual value that may be transferred between user accounts. The payment processor rule may limit an amount of virtual value that may be used from a particular provider or among multiple providers as a value source. Other types of rules may also be used.

Funding source data identifying value types that have value in the user account may be provided at block 812. The funding source data may be provided through an API, provided to a user through a user interface, or otherwise provided. For example, the user may be presented with one or more real value funding sources and/or one or more virtual value funding sources. The funding source data may include conversion rates of one or more real values and one or more virtual values to a base value.

An availability notification regarding availability to use the virtual value (or the portion of the virtual value) to fulfill the payment request may be provided at block 814. The availability notification may be provided through a pop window, a message, a tone, or may be otherwise provided. The availability notification may, in an example embodiment, be provided during check out or at the physical point of sale, with one or more items selected for purchase. The notification may provide encouragement to use virtual value from a virtual value funding source for the purchase.

A value type selection of a virtual value type of the value types may be received at block 816. The value type selection may select one or more virtual value types to fulfill the payment request.

The conversion rate may be accessed at block 818. The conversion rate may be accessed from the client machine 102, the payment processor 106, or otherwise accessed. The conversion rate may have been previously provided by the virtual value provider 108, agreed upon and set by the payment processor 106 and the virtual value provider 108, or otherwise accessed.

The conversion rate may be updated to obtain an updated conversion rate at block 820. For example, the conversion rate may change based on fluctuation on the value of the virtual value, on the value of a particular currency, or the like.

A portion of the virtual value associated with the account is converted to a base value of a base value type at a conversion rate in response to the receiving of the payment request at block 822. The conversion of the portion may be at the updated conversion rate. The conversion of the portion may be in response to the receiving of the value type selection. The conversion of the portion may be based on a determination that the payment request meets a compliance criterion. In an example embodiment, the virtual value may be pre-converted to the base value when the payee does not accept virtual value as a valid form of payment.

The payment request for the account is processed using the base value at block 824. The processing of the payment request may be based on a determination that the payment request meets the compliance criterion.

A payment processing notification may be provided based on the processing the payment request at block 826. The payment processing notification may be provided to the user, the value receiver 122, and/or the virtual value provider 108. The notification may be otherwise provided.

A converted value report may be generated based on the conversion of the portion at block 828. The generation of the converted value report may be further based on an item value of an item associated with the payment request, a virtual value purchase cost, and/or item historical value exchange data for the item. Other information may also be included on the converted value report. The converted value report may be provided to a user, provided to the virtual value provider 108, provided to a governmental entity (e.g., the Internal Revenue Service), or may be otherwise used.

In an example embodiment, the converted value report may be used to determine a valuation of virtual value used. For example, the converted value report may be used to assist a user with handling tax related issues.

In another example embodiment, the converted value report may be utilized to reconcile individual purchase transactions with an off-setting movement of real value from thea settlement account held by the virtual value provider 108 by the payment processor 106.

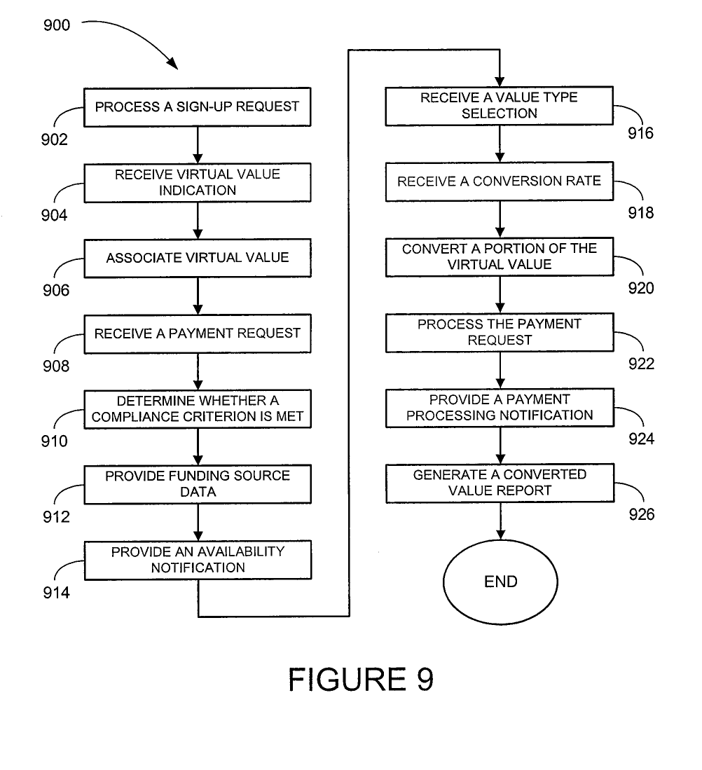

FIG. 9 illustrates a method 900 for payment request processing according to an example embodiment. The method 900 may be performed by the client machine 102 and/or the payment processor 106 of the system 100 (see FIG. 1) or otherwise performed.

The method 900 may be used to process a payment request using a portion of virtual value associated with a user account. The portion may be converted using a received conversion rate.

A sign-up request may be processed for the user at block 902. A virtual value indication associated with a user is received from the virtual value provider 108 at block 904.

At block 906, virtual value is associated with an account of the user based on the virtual value indication. A payment request is received at block 908.

A determination of whether the payment request meets a compliance criterion associated with the virtual value provider 108 may be made at block 910. Funding source data identifying value types having value in the account of the user may be provided at block 912.

An availability notification regarding availability to use the virtual value (or the portion of the virtual value) to fulfill the payment request may be provided at block 914. A value type selection of a virtual value type of the value types may be received at block 916.

The conversion rate may be received from the virtual value provider 108 at block 918. For example, the virtual value provider 108 may want to throttle or increase the amount of virtual value usage by respectively decreasing or increasing the conversion rate.

A portion of the virtual value associated with the account is converted to a base value of a base value type at a conversion rate in response to the receiving of the payment request at block 920. The conversion of the portion may be at the updated conversion rate. The conversion of the portion may be in response to the receiving of the value type selection. The conversion of the portion may be based on a determination that the payment request meets a compliance criterion.

The payment request for the account is processed using the base value at block 922. The processing of the payment request may be based on a determination that the payment request meets a compliance criterion.

A payment processing notification may be provided based on the processing the payment request at block 924. A converted value report may be generated based on the conversion of the portion at block 926.

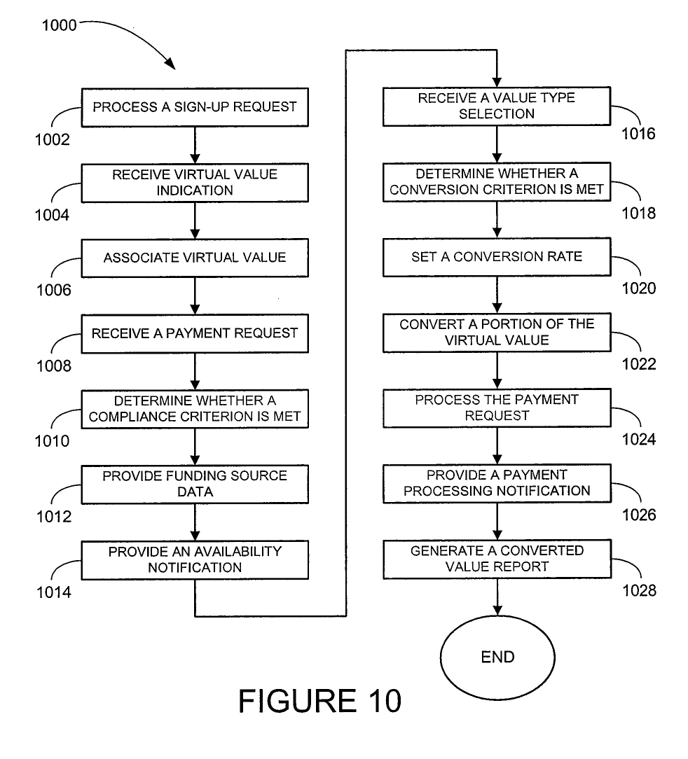

FIG. 10 illustrates a method 1000 for payment request processing according to an example embodiment. The method 1000 may be performed by the client machine 102 and/or the payment processor 106 of the system 100 (see FIG. 1) or otherwise performed.

The method 1000 may be used to process a payment request using a portion of virtual value associated with a user account. The portion may be converted using a conversion rate that is set based on a result of a determination of whether a user meets a conversion criterion.

A sign-up request may be processed for the user at block 1002. A virtual value indication associated with a user is received from the virtual value provider 108 at block 1004.

At block 1006, virtual value is associated with an account of the user based on the virtual value indication. A payment request is received at block 1008.

A determination of whether the payment request meets a compliance criterion associated with the virtual value provider 108 may be made at block 1010. Funding source data identifying value types having value in the account of the user may be provided at block 1012.

An availability notification regarding availability to use the virtual value (or the portion of the virtual value) to fulfill the payment request may be provided at block 1014. A value type selection of a virtual value type of the value types may be received at block 1016.

A determination of whether a conversion criterion is met may be made at block 1018. The conversion criterion may be used to determine whether the user receives a special conversion rate. A single criterion or multiple criteria may be used for the determination. Examples of conversion criterion include a virtual value threshold, a program entry date of the user, an amount of the payment request, an item associated with the payment request, or the like. For example, the virtual value threshold may enable the user to receive a different conversion rate (e.g., a better conversion rate) depending on an amount of virtual value available to the user through the payment processor 106 and/or the virtual value provider 108. The program entry date of the user may enable the user to receive a different conversion rate depending on when a user joined a program that qualifies for virtual value offered by the virtual value provider 108. The amount of the payment request may be used to enable the user to receive a different conversion rate depending on an amount of virtual value involved in the payment request.

The item associated with the payment request may be used to enable the user to receive a different conversion rate depending on a particular item or a group of items associated with the payment request. Other types of conversion criterion may also be used.

At block 1020, the conversion rate may be set based on a result of the determination of whether the user meets the conversion criterion. A portion of the virtual value associated with the account is converted to a base value of a base value type at a conversion rate in response to the receipt of the payment request at block 1022. The conversion of the portion may be at the updated conversion rate. The conversion of the portion may be in response to the receiving of the value type selection. The conversion of the portion may be based on a determination that the payment request meets the compliance criterion.

The payment request for the account is processed using the base value at block 1024. The processing of the payment request may be based on a determination that the payment request meets the compliance criterion.

A payment processing notification may be provided based on the processing the payment request at block 1026. A converted value report may be generated based on the conversion of the portion at block 1028.

The methods 800-1000 may reflect different example methods of accessing a conversion rate that may be used to convert a portion of the virtual value.

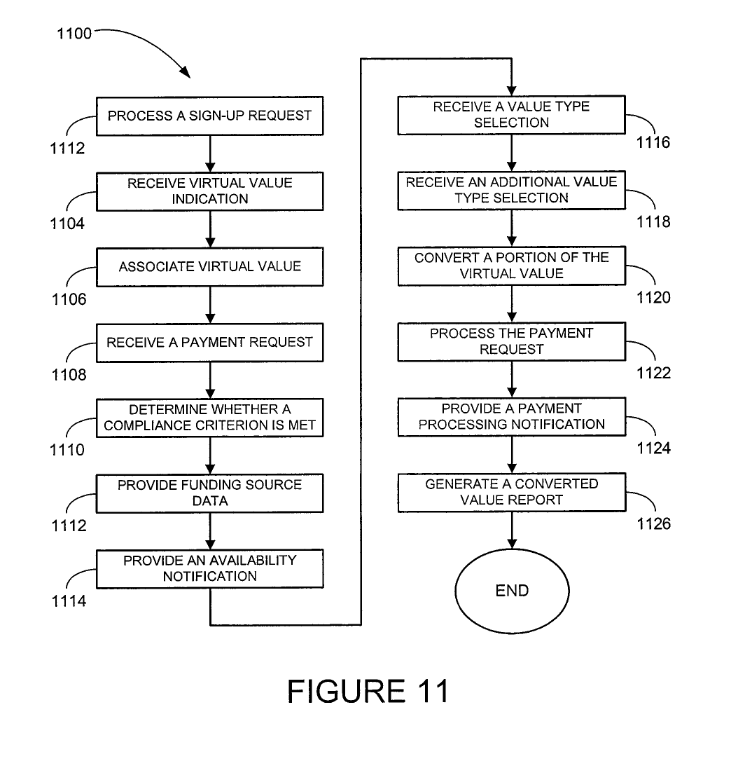

FIG. 11 illustrates a method 1100 for payment request processing according to an example embodiment. The method 1100 may be performed by the client machine 102 and/or the payment processor 106 of the system 100 (see FIG. 1) or otherwise performed.

The method 1100 may be used to process a payment request using a portion of virtual value associated with a user account and value from an additional finding source. The additional funding source may be a different type of virtual value or real value (e.g., currency). The use of multiple funding sources may enable a user to make better use of available forms of data. For example, a user may make a portion of payment using frequent flyer miles received from the virtual value provider 108 in which the user rarely earns frequent flyer miles and/or would not otherwise redeem the frequent flyer miles.

A sign-up request may be processed for the user at block 1102. A virtual value indication associated with a user is received from the virtual value provider 108 at block 1104.

At block 1106, virtual value is associated with an account of the user based on the virtual value indication. A payment request is received at block 1108. A determination of whether the payment request meets a compliance criterion associated with the virtual value provider 108 may be made at block 1110.

Funding source data identifying value types having value in the account of the user may be provided at block 1112. An availability notification regarding availability to use the virtual value (or the portion of the virtual value) to fulfill the payment request may be provided at block 1114.

A value type selection of a virtual value type of the value types may be received at block 1116. One or more additional value type selections of value types of the available value types may be received at block 1118.

A portion of the virtual value associated with the account is converted to a base value of a base value type at a conversion rate in response to the receiving of the payment request at block 1120. The conversion of the portion may be at an updated conversion rate. The conversion of the portion may be in response to the receiving of the value type selection. The conversion of the portion may be based on a determination that the payment request meets the compliance criterion. The conversion of the portion may be in response to the receiving of the value type selection and/or the additional value type selection.

The payment request for the account is processed using the base value at block 1122. The processing of the payment request may be based on a determination that the payment request meets a compliance criterion.

A payment processing notification may be provided based on the processing the payment request at block 1124. A converted value report may be generated based on the conversion of the portion at block 1126.

An example implementation of the methods 800-1100 may involve a user seeking to purchase a NINTENDO WII system for three hundred dollars or one hundred and fifty pounds. The user may purchase the NINTENDO WII using three hundred dollars. Alternatively, the user may use a corresponding amount of virtual value (e.g., 30,000 frequent flyer miles) to purchase the WII system with the payment processor 106 instead of the real value. The amount of the virtual value to purchase the NINTENDO WII may be determined by the payment processor 106. Once utilized to purchase the NINTENDO WII, the virtual value may be subtracted from the users account at the virtual value provider 108, and is credited in real value or virtual value with the value receiver 122.

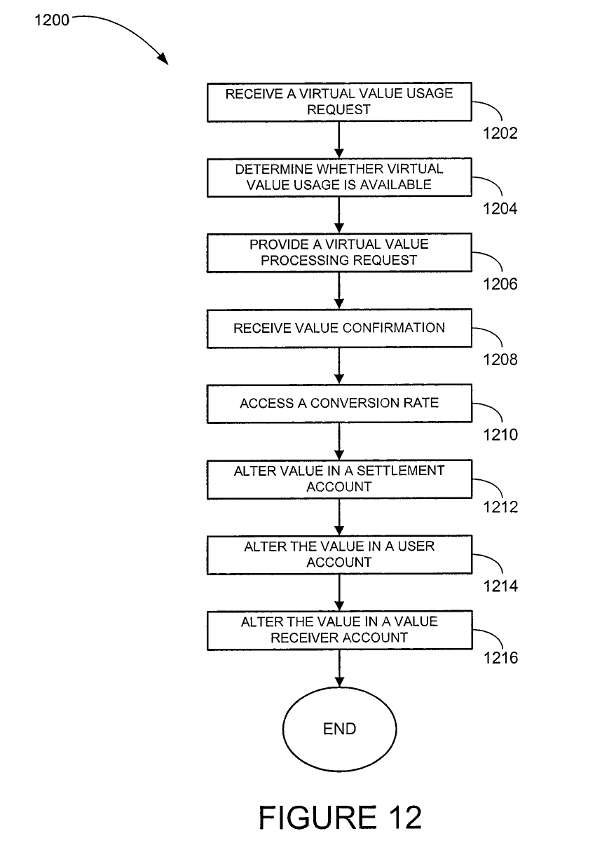

FIG. 12 illustrates a method 1200 for usage request processing according to an example embodiment. The method 1200 may be performed by the client machine 102 and/or the payment processor 106 of the system 100 (see FIG. 1) or otherwise performed.

The method 1200 may be used to process a virtual value usage request. The frequent flyer miles or other form of virtual value may be provided based on request from the virtual value provider 108 and may not be retained in a user account of the payment processor 106. Thus, the user may continue to use the virtual value with the virtual value provider 108 and may use the virtual value when desired with the payment processor 106.

A virtual value usage request associated with a user is received at block 1202. The virtual value usage request may include a virtual value amount of a virtual value type. The value receiver 122 may be identified in the virtual value usage request. The virtual value usage request may include a virtual value payment request, a virtual value borrow request, or a different type of virtual value usage request.

A determination of whether virtual value usage is available for the user may be made at block 1204. A virtual value processing request may be provided to the virtual value provider 108 at block 1206. The providing of the virtual value processing request may be based on a determination that the virtual value usage is available for the user. The virtual value processing request may be a virtual value payment processing request, a virtual value credit processing request, or a different type of virtual value processing request. The virtual value provider 108 may retain the authority and liability for determinations on whether the user may spend virtual value. The virtual value provider 108 may delegate this responsibility to another party, including the payment processor 106, or other parties. However, any such delegation may not remove the responsibility of the virtual value provider 108.

Value confirmation may be received from the virtual value provider 108 at block 1208. A conversion rate for the virtual value type is accessed at block 1220. The conversion rate may be accessed by identifying the conversion rate, receiving the conversion rate from the conversion rate provider 120, or may be otherwise accessed.

Value in a settlement account of the virtual value provider 108 is altered at block 1212 based on the virtual value amount and the conversion rate. The alteration of the value in the settlement account may be in response to the receiving of the value confirmation.

The value in the settlement account may be decreased when the user is utilizing virtual value to pay. Thus, the virtual value provider 108 provides value to the payment processor 106 for the use of the virtual value to fund the virtual value usage request. By way of an example, if an enrolled user purchases a product offered for sale on the marketplace provider 124 using frequent flier miles offered by the virtual value provider 108, the payment processor 106 may access the conversion rate from the conversion rate provider 120, deducting the equivalent amount of real value or currency from the settlement account and crediting the value receiver 122 that same amount of real value or currency, minus any fees for the payments.

Likewise, the value in the settlement account may be increased when the user is receiving virtual value as payment, or otherwise purchasing virtual value. The value in the settlement account may be adjusted otherwise. By way of an example, if an enrolled user identifies a seller or merchant of the marketplace provider 124 that publishes a price for an item only in a virtual value and that user does not have any virtual value, the consumer may use real value to purchase that item. The payment processor 106 may access the conversion rates from the conversion rate provider 120, and convert the real value into virtual value, subtracting the real value or currency from the user's account, and crediting the value receiver 122 with virtual value, and crediting the settlement account with the real value or currency, minus any fees. In effect, the user may purchase virtual value with real value, and that virtual value may be added to the value receiver's account while real value was credited to the settlement account.

The value may reflect an entire amount of the virtual value amount, may be a greater amount than the virtual amount, or less than the virtual value amount. For example, the amount may be greater when the virtual value provider 108 is responsible for paying a transaction fee to the payment processor 106 and the amount may be less when the payment processor 106 offers a special promotion rate to the virtual value provider 108. The transaction fee may be a fixed or variable fee. For example, the transaction fee may be 3% of the virtual value usage request, greater than 3% of the virtual value usage request, or less than 3% of the virtual value usage request.

Value in a user account associated with the user may be altered at block 1214 based on the virtual value amount and the conversion rate. Value in a value receiver account associated with the value receiver 122 may be altered at block 1216 based on the virtual value amount and the conversion rate.

In an example embodiment, the receiving of the value confirmation at block 1208 may enable delayed processing of the operations performed at block 1212, block 1214, and/or block 1216. For example, the payment processor 106 may batch process alteration of value at a specified time, when a threshold number of processing requests are queued, or at a different time.

An example implementation of the method 1200 may involve a user seeking to purchase a NINTENDO WII system for three hundred dollars or one hundred and fifty pounds. The user may use a corresponding amount of virtual value (e.g., 30,000 frequent flyer miles) to purchase the NINTENDO WII system with the payment processor 106 instead of the real value. The amount of the virtual value may be determined by the payment processor 106 and the conversion rate may be ascertained from the conversion rate provider 120. If the value receiver 122 requested real value, the payment processor 106 may deposit that real value in the account of the value receiver 122, and may also deduct the virtual value amount from the user's account with the virtual value provider 108, while simultaneously deducting the equivalent real value or currency amount from the settlement account of the virtual value provider 108. If the value receiver 122 requested virtual value, the payment processor 106 may transfer the virtual value amount from the user account to the value receiver 122 account, while the real value held in the settlement account would remain the same value, minus any fees.

In an example embodiment, the methods may convert the virtual value to real value instead of simply retaining the virtual value in the provided format because of a rule of the payment processor 106 and/or the virtual value provider 108. For example, the rule may be that virtual value is not transferable to a particular user, to a group of users, or any other user. The rule may be enforced by one or more of the following modules and methods: the compliance criterion determination module 218, compliance criterion determination module 410, compliance criterion determination module 506, compliance request provider module 508, compliance authentication receiver module 510, determine whether a compliance criterion is met 810, determine whether a compliance criterion is met 910, determine whether a compliance criterion is met 1010, determine whether a compliance criterion is met 1110, or others.

An example implementation of the method 1200 may involve the user using oil as the virtual value. In the case of oil or other commodities, the virtual value provider 108, the payment processor 106, and/or the conversion rate provider 120, may establish a uniform transaction measure for that commodity. For oil, Barrels may be the measure adopted. Whatever measure is selected may be utilized to measure the virtual value against other real values. So, if an item is selling on the marketplace provider 124 for $100, a user may purchase that item for $100 or one Barrel, if the conversion rate provider 120 equates one Barrel to $100, and the virtual value provider 108 offers deposits and lending in oil. The user can have a portion of the oil converted (e.g., by the payment processor 106 or another party) for usage, or a portion of the oil may be designated for conversion until the user restores the value.

Another example implementation of method 1200 may involve gold or some other precious commodity. Similar to oil, the virtual value provider 108, payment processor 106, and conversion rate provider 120, may agree on a standard measure, such as ounces or grams. That measure may be utilized to measure the virtual value against other real values. With gold, if an item is selling on the marketplace provider 124 for $100, a user may purchase that item for $100 or one-tenth of an ounce of gold, if the conversion rate provider 120 equates one ounce of gold to $1,000 and the virtual value provider 108 offers deposits and lending in gold.

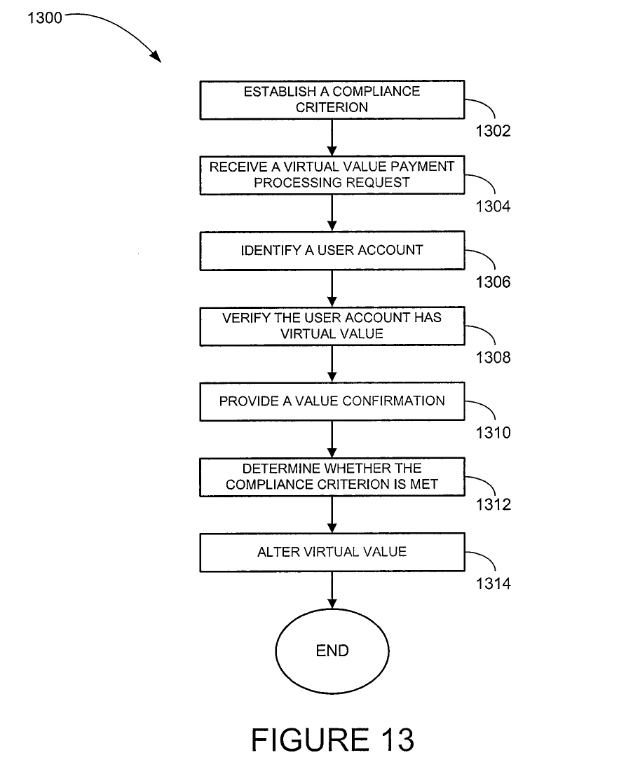

FIG. 13 illustrates a method 1300 for virtual value processing according to an example embodiment. The method 1300 may be performed by the virtual value provider 108 of the system 100 (see FIG. 1) or otherwise performed.

The method 1300 may alter virtual value associated with a user account based on receipt of a virtual value payment processing request.

A compliance criterion may be established for the virtual value payment processing request at block 1302. A virtual value payment processing request is received from the payment processor 106 at block 1304. The virtual value payment processing request may include a virtual value amount and an account identifier.

A user account is identified based on the account identifier at block 1306. Verification that the user account has virtual value in the virtual value amount is made at block 1308.

A value confirmation is provided to the payment processor 106 at block 1310 based on verification that the user account has virtual value in the virtual value amount.

A determination of whether the compliance criterion is met for the virtual value payment processing request may be made at block 1312. The virtual value is altered in the user account by the virtual value amount at block 1314. The alteration of the virtual value may be based on a determination that the compliance criterion is met.

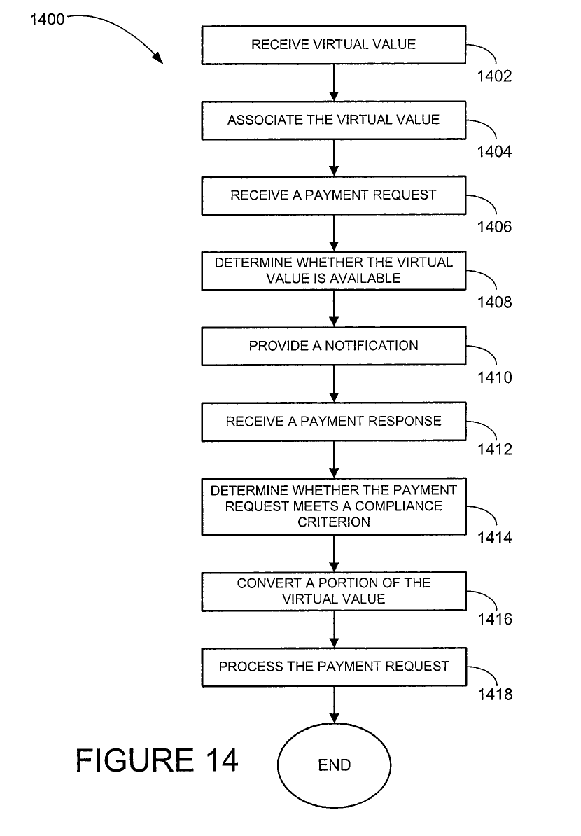

FIG. 14 illustrates a method 1400 for payment request processing according to an example embodiment. The method 1400 may be performed by the client machine 102 and/or the payment processor 106 of the system 100 (see FIG. 1) or otherwise performed.

The method 1400 may alter virtual value associated with a user account based on receipt of a virtual value payment processing request.

Virtual value associated with the user may be received from a virtual value provider at block 1402. The virtual value may be associated with the user account at block 1404.

A payment request associated with a user account is received at block 1406. A determination of whether virtual value is available to the user account is made at block 1408.

Notification regarding the availability of the virtual value to the user account may be provided at block 1410. A payment response to the notification may be received at block 1412.

A determination of whether the payment request meets a compliance criterion associated with the virtual value provider 108 may be made at block 1414.

A portion of the virtual value is converted to a base value of a base value type at a conversion rate in response to the determining at block 1416. The conversion of the portion may be based on the receiving of the payment response. The conversion of the portion may be based on a determination that the payment request meets the compliance criterion.

The payment request may be processed for the account using the base value at block 1418. The processing of the payment may be based on a determination that the payment request meets the compliance criterion.

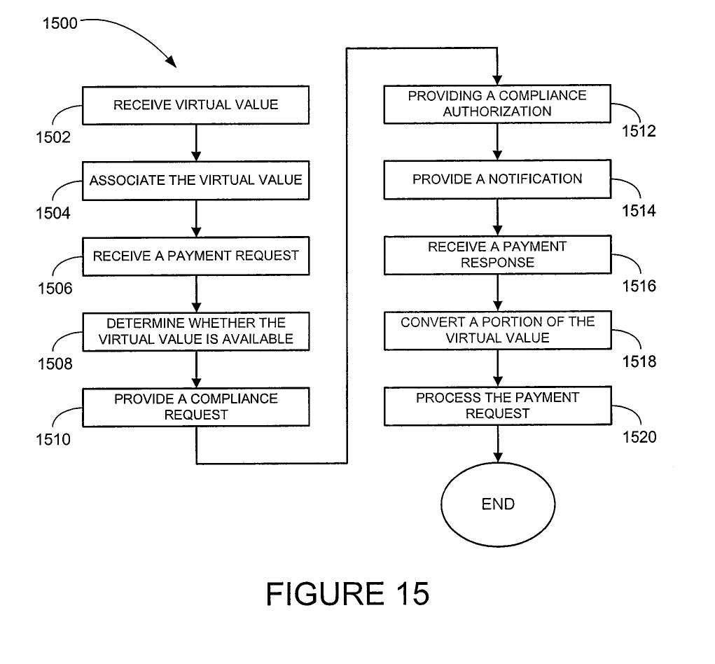

FIG. 15 illustrates a method 1500 for payment request processing according to an example embodiment. The method 1500 may be performed by the client machine 102 and/or the payment processor 106 of the system 100 (see FIG. 1) or otherwise performed.

Virtual value associated with the user may be received from a virtual value provider at block 1502. The virtual value may be associated with the user account at block 1504.

A payment request associated with a user account is received at block 1506. A determination of whether virtual value is available to the user account is made at block 1508.

A compliance request may be provided to the virtual value provider 108 at block 1510. A compliance authorization may be received from the virtual value provider 108 in response to providing the compliance request at block 1512.

Notification regarding the availability of the virtual value to the user account may be provided at block 1514. A payment response to the notification may be received at block 1516.

A portion of the virtual value is converted to a base value of a base value type at a conversion rate in response to the determining at block 1518. The conversion of the portion may be based on the receiving of the payment response. The conversion of the portion may be based on the receiving of the compliance authorization.

The payment request may be processed for the account using the base value at block 1520. The processing of the payment may be based on the receiving of the compliance authorization.

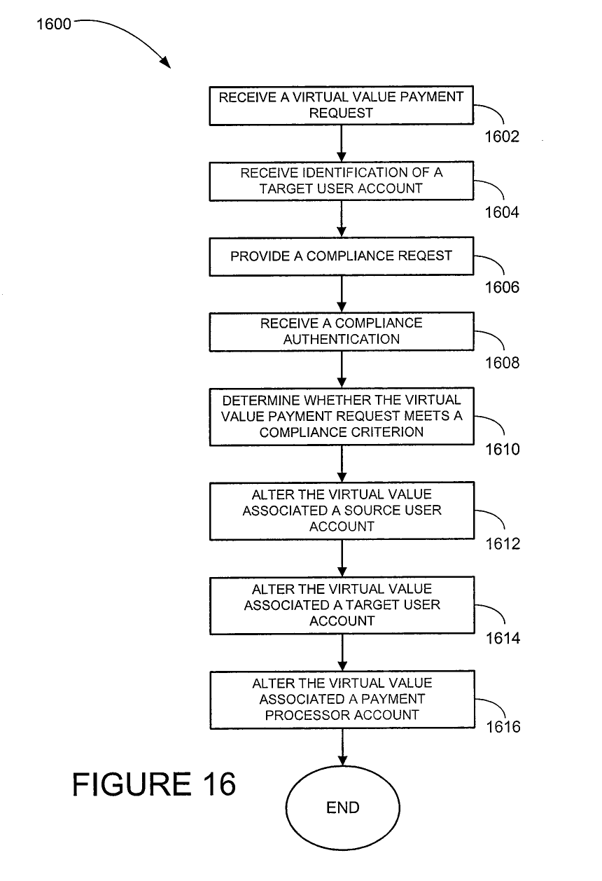

FIG. 16 illustrates a method 1600 for payment request processing according to an example embodiment. The method 1600 may be performed by the client machine 102 and/or the payment processor 106 of the system 100 (see FIG. 1) or otherwise performed.

The method 1600 may be used to alter virtual value associated with a source user account and a target user account in response to receipt of a virtual value payment request. The virtual value associated with a payment processor account may also be modified in response to receipt of a virtual value payment request. A source user may then provide payment using virtual value by using the method 1600 in which a target user may receive the provided virtual value.

A virtual value payment request is received for a source user account at block 1602. The virtual value payment request may include a payment amount.

Identification of the target user account may be received at block 1604. A compliance request may be provided to the virtual value provider 108 at block 1606.

A compliance authentication may be received from the virtual value provider 108 in response to providing the compliance request at block 1608. A determination of whether the virtual value payment request meets a compliance criterion associated with the virtual value provider 108 may be made at block 1610.

Virtual value associated with the source user account is altered based on the payment amount at block 1612. The alteration of the virtual value may be based on a determination that the payment request meets the compliance criterion and/or on receipt of the compliance authentication.

Virtual value associated with a target user account is altered based on the payment amount at block 1614. The alteration of the virtual value may be based on a determination that the payment request meets the compliance criterion and/or on receipt of the compliance authentication. The alteration of the virtual value of the target user account may be in real-time with the alteration of the virtual value of the source use account or may be at a delay. In an example embodiment, the virtual value may be retained by the payment processor 106 until the target use account is designated.

The virtual value associated with a payment processor account may be altered at block 1616 based on the payment amount. The alteration of the virtual value may be based on a determination that the payment request meets the compliance criterion and/or on receipt of the compliance authentication.

In an example embodiment, the method 1600 may enable the target user to accept an alternate method of payment beyond real value. The target user may be able to use the received virtual value for redemption opportunities with the virtual value provider 108 or others that the target user may not otherwise have. For example, the target user may receive 100,000 frequent flyer miles for selling a variety of items. The target user may redeem the frequent flyer miles with the virtual value provider 108 (e.g., an airline) to obtain a business class ticket to Europe. The cost of purchasing the business ticket may exceed the amount of real value that the target user could obtain by converting the 100,000 frequent flyer miles to real value.

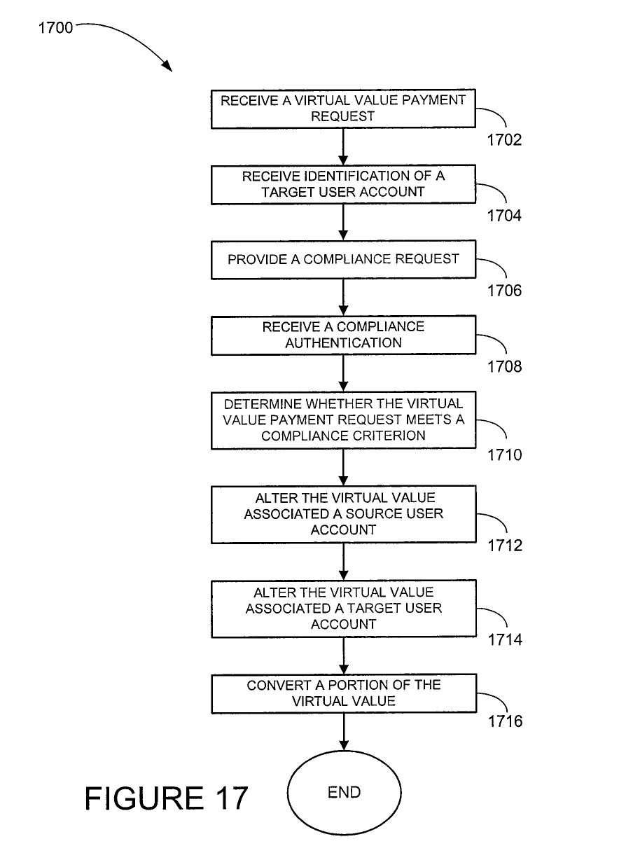

FIG. 17 illustrates a method 1700 for payment request processing according to an example embodiment. The method 1700 may be performed by the client machine 102 and/or the payment processor 106 of the system 100 (see FIG. 1) or otherwise performed.

The method 1700 may be used to alter virtual value associated with a source user account and a target user account in response to receipt of a virtual value payment request. A portion of the virtual value may be converted.

A virtual value payment request is received for a source user account at block 1702. The virtual value payment request may include a payment amount.

Identification of the target user account may be received at block 1704. A compliance request may be provided to the virtual value provider 108 at block 1706.

A compliance authentication may be received from the virtual value provider 108 in response to providing the compliance request at block 1708. A determination of whether the virtual value payment request meets a compliance criterion associated with a virtual value provider may be made at block 1710.

Virtual value associated with the source user account is altered based on the payment amount at block 1712. The alteration of the virtual value may be based on a determination that the payment request meets the compliance criterion and/or on receipt of the compliance authentication.

Virtual value associated with a target user account is altered based on the payment amount at block 1714. The alteration of the virtual value may be based on a determination that the payment request meets the compliance criterion and/or on receipt of the compliance authentication. A portion of the virtual value associated with the source user account may be converted at block 1716.

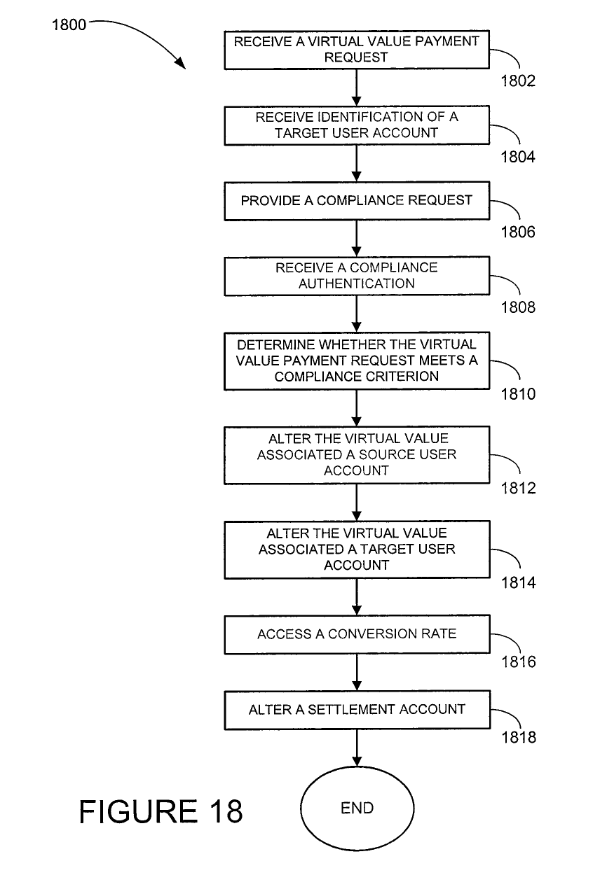

FIG. 18 illustrates a method 1800 for payment request processing according to an example embodiment. The method 1800 may be performed by the client machine 102 and/or the payment processor 106 of the system 100 (see FIG. 1) or otherwise performed.

The method 1800 may be used to alter virtual value associated with a source user account and a target user account in response to receipt of a virtual value payment request. A settlement account may be altered in response to the receipt of the virtual value payment request.

A virtual value payment request is received for a source user account at block 1802. The virtual value payment request may include a payment amount. Identification of the target user account may be received at block 1804.

A compliance request may be provided to the virtual value provider 108 at block 1806. A compliance authentication may be received from the virtual value provider 108 in response to providing the compliance request at block 1808.

A determination of whether the virtual value payment request meets a compliance criterion associated with a virtual value provider may be made at block 1810.

Virtual value associated with the source user account is altered based on the payment amount at block 1812. The alteration of the virtual value may be based on a determination that the payment request meets the compliance criterion and/or on receipt of the compliance authentication.

Virtual value associated with a target user account is altered based on the payment amount at block 1814. The alteration of the virtual value may be based on a determination that the payment request meets the compliance criterion and/or on receipt of the compliance authentication.

A conversion rate for the virtual value may be accessed at block 1816 based on a virtual value type of the virtual value. A settlement account of the target user may be altered at block 1818 based on the payment amount and the conversion rate.

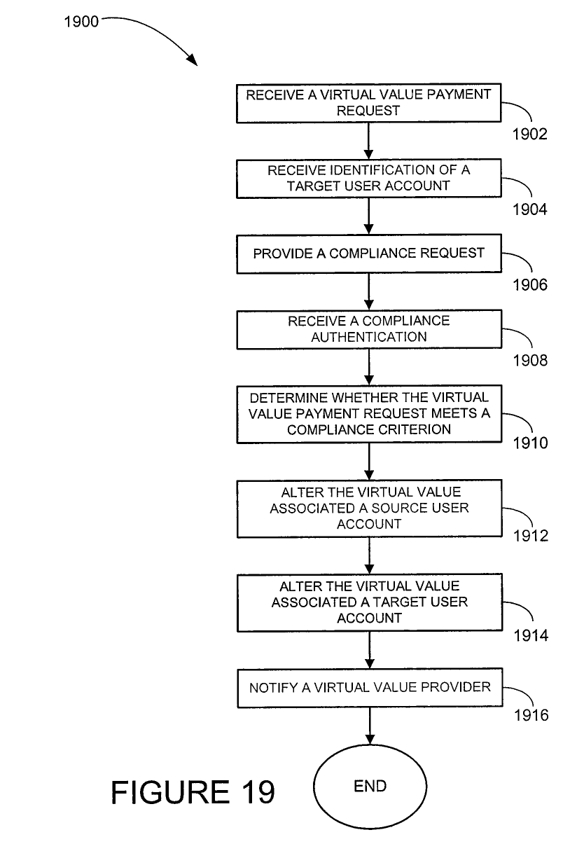

FIG. 19 illustrates a method 1900 for payment request processing according to an example embodiment. The method 1900 may be performed by the client machine 102 and/or the payment processor 106 of the system 100 (see FIG. 1) or otherwise performed.

The method 1900 may be used to alter virtual value associated with a source user account and a target user account in response to receipt of a virtual value payment request. The virtual value provider 108 may be notified in response to receipt of the virtual value payment request.

A virtual value payment request is received for a source user account at block 1902. The virtual value payment request may include a payment amount. Identification of the target user account may be received at block 1904.

A compliance request may be provided to a virtual value provider at block 1906. The virtual value provider may be capable of determining whether the virtual value payment request meets a compliance criterion associated with the virtual value provider 108.

A compliance authentication may be received from the virtual value provider 108 in response to providing the compliance request at block 1908.

A determination of whether the virtual value payment request meets a compliance criterion associated with the virtual value provider 108 may be made at block 1910.

Virtual value associated with the source user account is altered based on the payment amount at block 1912. The alteration of the virtual value may be based on a determination that the payment request meets the compliance criterion and/or on receipt of the compliance authentication.

Virtual value associated with a target user account is altered based on the payment amount at block 1914. The alteration of the virtual value may be based on a determination that the payment request meets the compliance criterion and/or on receipt of the compliance authentication.

A virtual value provider may be notified of the altering of the virtual value associated with the target user account at block 1916. The virtual value provider 108 may use the received notification to track a total account value association for the target user account. The total account value association may include lifetime miles, lifetime points, programs to date miles, program to date points, or the like.

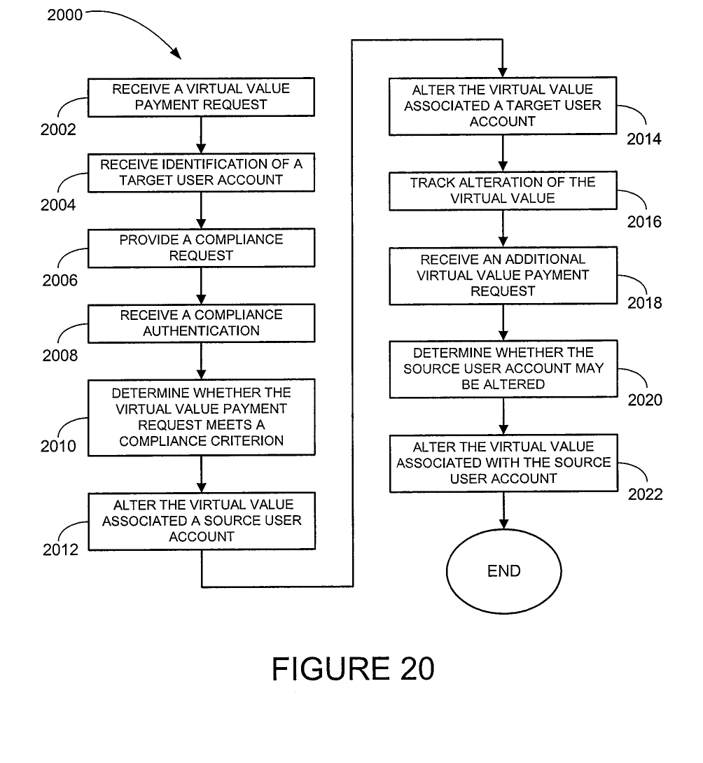

FIG. 20 illustrates a method 2000 for payment request processing according to an example embodiment. The method 2000 may be performed by the client machine 102 and/or the payment processor 106 of the system 100 (see FIG. 1) or otherwise performed.

The method 2000 may be used to alter virtual value associated with a source user account and a target user account in response to receipt of a virtual value payment request. The alteration of the virtual value may be tracked.

A virtual value payment request is received for a source user account at block 2002. The virtual value payment request may include a payment amount.

Identification of the target user account may be received at block 2004. A compliance request may be provided to a virtual value provider at block 2006.

A compliance authentication may be received from the virtual value provider in response to the providing of the compliance request at block 2008. A determination of whether the virtual value payment request meets a compliance criterion associated with the virtual value provider 108 may be made at block 2010.

Virtual value associated with the source user account is altered based on the payment amount at block 2012. The alteration of the virtual value may be based on a determination that the payment request meets the compliance criterion and/or on receipt of the compliance authentication.

Virtual value associated with a target user account is altered based on the payment amount at block 2014. The alteration of the virtual value may be based on a determination that the payment request meets the compliance criterion and/or on receipt of the compliance authentication.

The alteration of the virtual value associated with the source user account and/or the target user account may be tracked at block 2016. The tracking may be tracked through a counter or otherwise. The tracking may be used to limit an amount of virtual value that may be received or provided during a time period.

In an example embodiment, the tracking of the alteration of virtual value may prevent users from facilitating certain virtual value transfer arrangements. The tracking may enable the virtual value received from the virtual value provider 108 to be used differently than the virtual value received as part of the fulfilling of a payment request or other type of usage request. For example, MARRIOTT may permit use of its MARRIOTT REWARDS points to obtain a reward ticket on AMERICAN AIRLINES or to convert its MARRIOTT REWARDS points to AMERICAN AIRLINES AADVANTAGE frequent flyer miles but not to obtain a free stay at a HILTON hotel. Likewise, NORTHWEST AIRLINES may be the virtual value provider 108 and may permit use of its WORLDPERKS frequent flier miles for conversion into HERTZ #1 CLUB points for a rental car, but not to obtain FLYING CLUB frequent flier miles from VIRGIN ATLANTIC.

An additional virtual value payment request may be received for the source user account at block 2018. The additional virtual value payment request may include an additional payment amount.

A determination of whether the source user account may be altered by the additional payment amount may be made at block 2020 based on the tracking of the source user account.

The virtual value associated with the source user account may be altered based on the additional payment amount at block 2022.

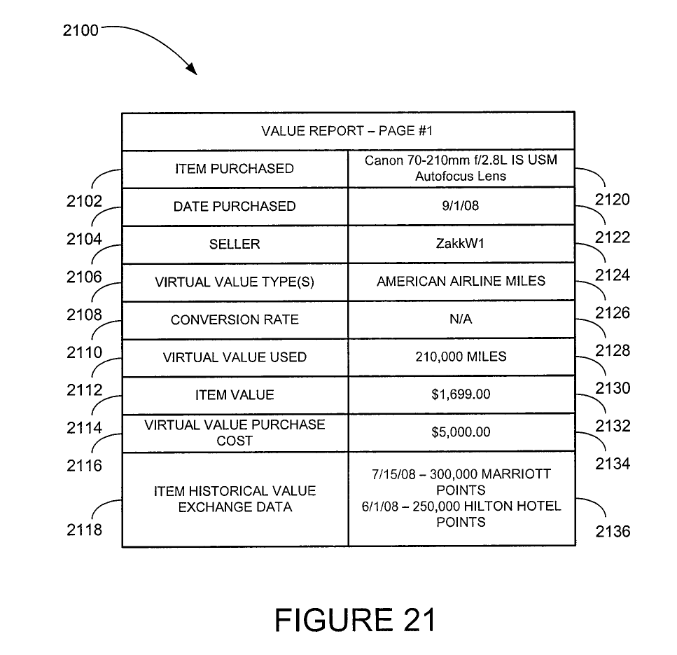

FIG. 21 is an example diagram of a converted value report 2100 according to an example embodiment. The converted value report 2100 may be generated during the operations performed at block 826, block 926, block 1028, and/or block 1126 (see FIGS. 8-11). The converted value report 2100 may be presented to a user in a user interface, provided to a user in hard copy, stored in the database 116, or may be otherwise used.

The converted value report 2100 may include an item purchased identifier 2102, a date purchased identifier 2104, a seller identifier 2106, a virtual value types identifier 2108, a conversion rate identifier 2110, a virtual value used identifier 2112, an item value identifier 2114, a virtual value purchase cost identifier 2116 which may include a buy rate, sell rate, a midpoint rate, and/or any fees associated with the conversion, and/or an item historical value exchange data identifier 2118. Other identifiers may also be included.

The converted value report may include an item purchased field 2120, a date purchased field 2122, a seller field 2124, a virtual value types field 2126, a conversion rate field 2128 which may include a buy rate, sell rate, a midpoint rate, and/or any fees associated with the conversion, a virtual value used field 2130, an item value field 2132, a virtual value purchase cost field 2134, and/or an item historical value exchange data field 2136. Other fields may also be included. The identifiers 2102-2118 may correspond to the fields 2120-2136.

The item purchased field 2120 reflects that the item purchased is a Canon 70-210 mm f/2.8 L IS USM Autofocus Lens. The date purchased field 2122 reflects that the item was purchased on Sep. 1, 2108. The seller field 2124 reflects that the seller of the item is “ZakkW1”. The virtual value type(s) field 2126 reflects that the virtual value used was AMERICAN AIRLINE AADVANTAGE frequent flyer miles. The conversion rate field 2128 includes null data. However, the conversion rate field 2128 may include a conversion rate used to convert the virtual value into real value. The virtual value used field 2130 reflects that 210,000 miles were used to purchase the item. The item value field 2132 reflects a retail value of the item. The virtual value purchase cost field 2134 reflects the cost to purchase the virtual value from the virtual value provider 108. The item historical value exchange data field 2136 reflects previous amounts of virtual value used to purchase the item.

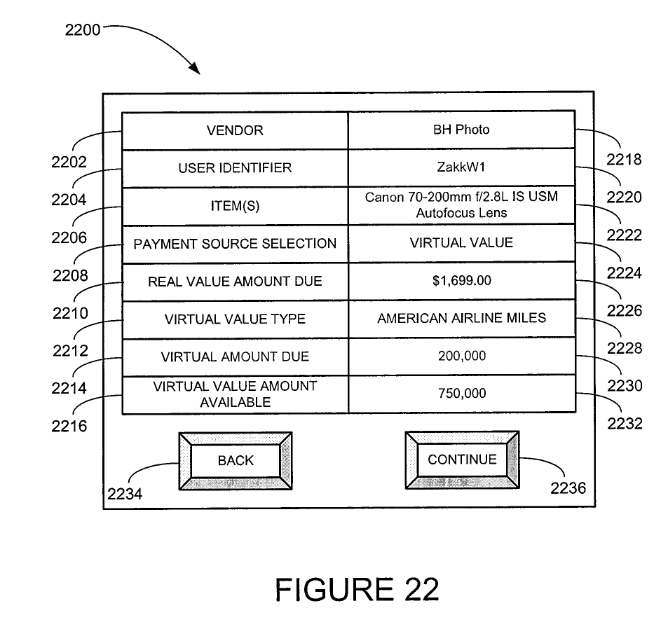

FIG. 22 is an example diagram of a user interface 2200 according to an example embodiment. The user interface 2200 may be presented to a user of the client machine 102 or otherwise provided. The user interface 2200 may be presented to the user prior to performing the operations at block 820, block 920, block 1022, block 1120, block 1212, block 1314, block 1416, block 1518, block 1612, block 1712, block 1812, block 1912, and/or block 2022 (see FIGS. 8-20). The user interface 2200 may be presented at other times during the methods 800-2000. The user interface may be otherwise presented.

The user interface 2200 may include a vendor identifier 2202, a user identifier 2204, an items identifier 2206, a payment source selection identifier 2208, a real value amount due identifier 2210, a virtual value type identifier 2212 which may be changed to any supported virtual value type identifiers, a virtual amount due identifier 2214, and/or a virtual value amount available identifier 2216.

The user interface may include a vendor field 2218, a user identifier field 2220, an items field 2222, a payment source selection field 2224, a real value amount due field 2226, a virtual value type field 2228 which may be changed to any supported virtual value type identifiers, a virtual amount due field 2230, and/or a virtual value amount available field 2232. Other fields may also be included. The identifiers 2202-2016 may correspond to the fields 2218-2232.

The vendor field 2218 reflects that the vendor for one or more items is “BH Photo”. The user identifier field 2220 reflects that the user that is initiating the payment request is identified as “ZakkW1”. The items field 2222 reflects that the item is a Canon 70-200 mm f/2.8 L IS USM Autofocus Lens.

The payment source selection field 2224 reflects that the payment source selected is virtual value. Multiple payment sources may be selected and reflected in the payment source selection field 2224.

The real value amount due field 2226 reflects a real value amount due for the item. The virtual value type field 2228 reflects the virtual value type selection for the payment source selected in the payment source selection identifier 2208.

The virtual amount due field 2230 reflects the amount of virtual value due for the item. The virtual value amount available field 2232 reflects an amount of virtual value available to the user based on a balance account or available through the virtual value provider 108.

A back button 2234 and a continue button 2236 may also be included in the user interface 2200. The back button 2234 may enable the user to return to a previous screen to, by way of example, select a different payment source, a different item, a different vendor, a different item, or the like. The continue button 2236 may be used to process the payment request or usage request.

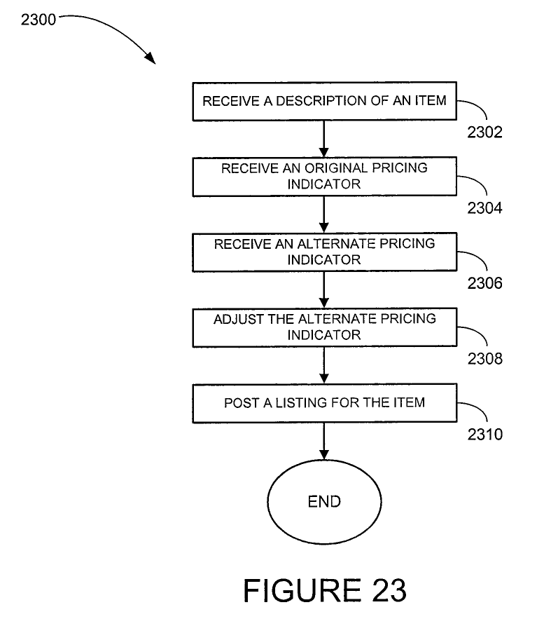

FIG. 23 illustrates a method 2300 for item listing according to an example embodiment. The method 2300 may be performed by the client machine 102 and/or the marketplace provider 124 of the system 100 (see FIG. 1) or otherwise performed.

The method 2300 may be used to receive prices for an item in different value types (e.g., real or virtual currencies). The original pricing indicator and the alternate pricing indicator may both be received and used with the listing.

A description of an item may be received at block 2302. The description may describe the item and be used to entice a potential buyer to purchase. The description may be prepared by a user of the client machine 102 or may be otherwise prepared.

An original pricing indicator of a base value type for an item is received at block 2304. The original price may include real value and/or virtual value. The original pricing indicator may include the original price to be included in the listing or a value to be adjusted to obtain the original price. For example, the original pricing indicator may include a fee that may be charged by the marketplace 124 (see FIG. 1) that will not be included in the original price.

An alternate pricing indicator of the alternate value type for the item may be received at block 2306. The alternate pricing indicator may include the alternate price or a value to be adjusted to obtain the alternate price. For example, the alternate pricing indicator may include a fee that may be charged by the marketplace 124 (see FIG. 1) that will not be included in the alternate price.

At block 2308, the alternate pricing indicator may be adjusted by a marketplace fee to obtain the alternate value. The alternate value may include real value and/or virtual value.

A listing for the item is posted in a network-based marketplace at block 2310. The listing may include an original price of the base value type based on the original pricing indicator and an alternate price of an alternate value type. The original price may have a different value than the alternate price. The listing may include the description

By way of example, a seller on eBay as the marketplace provider 126 may want to price an item in several real values or currencies, including US Dollars, Pounds Sterling, and Euros, and in several virtual values, issued by various virtual value providers 108, including DISNEY DOLLARS issued by the WALT DISNEY COMPANY as the virtual value provider 108, TORONTO DOLLARS issued by the TORONTO DOLLAR COMMUNITY PROJECTS INC. as the virtual value provider 108 and MILEAGE PLAN frequent flier miles issued by ALASKA AIRLINES as the virtual value provider 108. By pricing an item in multiple real and virtual values, the seller may appeal to a larger market. Users wishing to help the poor in Toronto may want to spend only TORONTO DOLLARS. Users that have unused DISNEY DOLLARS from a recent trip to one of the DISNEY theme parks or DISNEY cruise lines, may want to spend these dollars. Likewise, a seller may desire one real or virtual value over another, for various reasons. If the seller wants a free trip to Alaska, MILEAGE PLAN frequent flier miles may help the seller achieve that free trip easier than currency from one or more real values. If the seller is also interested in assisting the poor, the seller may also want to accept TORONTO DOLLARS in exchange for the item. Having the ability to price, sell, and buy items on the marketplace provider 126 in one or more real or virtual values may enable increased sales for the seller and a better experience for the user or buyer.

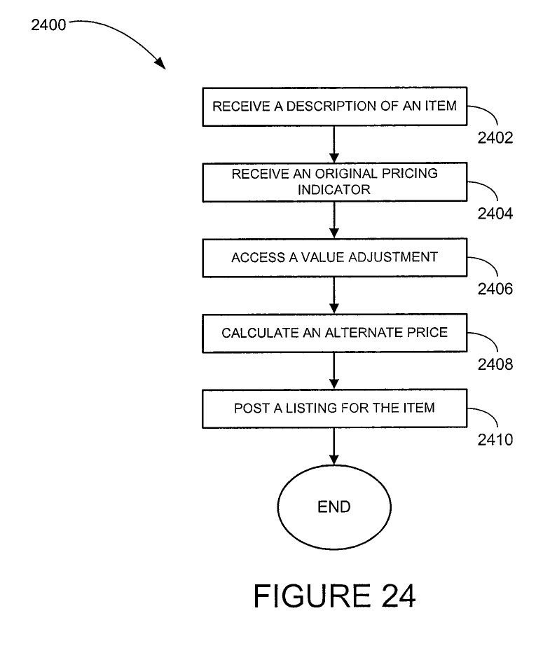

FIG. 24 illustrates a method 2400 for item listing according to an example embodiment. The method 2400 may be performed by the client machine 102 and/or the marketplace provider 124 of the system 100 (see FIG. 1) or otherwise performed.

The method 2400 may be used to receive a price for an item in a first currency type, adjust the price for a second currency type, and post a listing including both the first currency type and the second currency type. The value of the first currency type and the second currency type may not be equal based on the adjustment.

A description of an item may be received at block 2402. An original pricing indicator of a base value type for an item is received at block 2404.

A value adjustment for the alternate value type may be accessed at block 2406. The alternate price may be calculated at block 2408 based on the original price and the value adjustment. The value adjustment may be provided by a user of the client machine 102, the payment processor 106, the marketplace provider 126, or may be otherwise provided.

The value adjustment may be a price discount or a price increase over the original price. For example, a price discount may be used as the value adjustment to encourage a buyer to purchase an item using the alternate value price. The price increase may be used to discourage a buyer from purchasing the item using the alternate value price. By way of example, if the seller of the marketplace provider 124 was planning a trip to Ithaca, N.Y., USA, the seller may lower the price for an item for sale on the marketplace provider 124 if the sale is transacted in ITHACA HOURS, a virtual value that circulates in that town. Lowering the price may provide an incentive for users to purchase using this virtual value, as opposed to a real value, such as US Dollars. If utilized in the purchase, these ITHACA HOURS may assist the seller with future transactions in Ithaca, N.Y., USA, without further currency conversion costs that may be incurred if the seller converted US Dollars into ITHACA HOURS.

A listing for the item is posted in a network-based marketplace at block 2410. The listing may include an original price of the base value type based on the original pricing indicator and an alternate price of an alternate value type. The original price may have a different value than the alternate price. The posting of the listing for the item in the network-based marketplace may include the description.

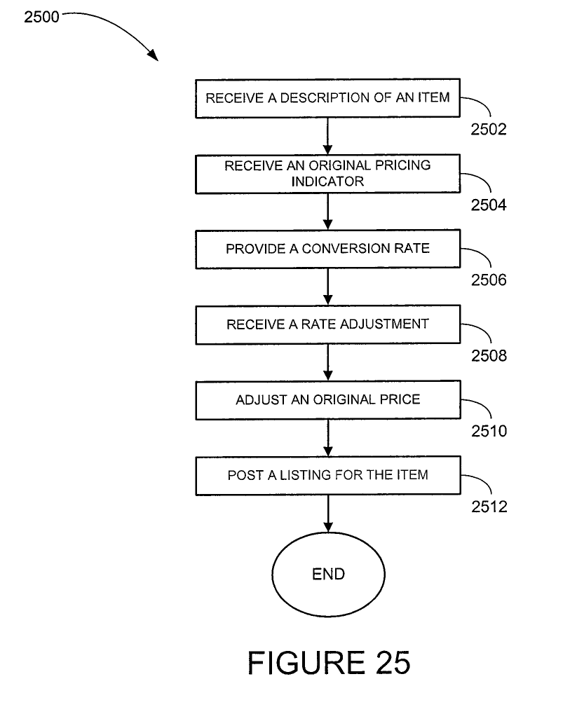

FIG. 25 illustrates a method 2500 for item listing according to an example embodiment. The method 2500 may be performed by the client machine 102 and/or the marketplace provider 124 of the system 100 (see FIG. 1) or otherwise performed.

The method 2500 may be used to receive a price for an item in a first currency type, receive a rate adjustment for a second currency type, set the value for the second currency type based on the rate adjustment, post a listing including both the first currency type and the second currency type. The value of the first currency type and the second currency type may not be equal based on the adjustment.

A description of an item may be received at block 2502. An original pricing indicator of a base value type for an item is received at block 2504.

A conversion rate from the base value type to the alternate value type may be provided at block 2506. The conversion rate may reflect the user's value of the alternate value type related to the based value type. The conversion rate may reflect a conversion rate previously received from the payment processor 106, the virtual value provider 108, and/or the marketplace provider 124.

The conversion rate may be provided at the direction of the user of the client machine 102. The conversion rate may be provided to the payment processor 106, the virtual value provider 108, and/or the marketplace provider 124. The conversion rate may be otherwise provided.

A rate adjustment for the conversion rate may be received at block 2508. The conversion rate may be received from the payment processor 106, the virtual value provider 108, the marketplace provider 124, or may be otherwise received. The rate adjustment may reflect additional value to be provided by the provider of the rate adjustment if the seller successfully sells the item and receives payment in the alternate currency type. The rate adjustment may be received to notify the seller of enhanced base value the seller may receive when later converting a virtual value type (e.g., frequent flyer miles) into a real value type (e.g., US dollars).

At block 2510, the original price may be adjusted using the conversion rate and the rate adjustment to set the alternate price.

A listing for the item is posted in a network-based marketplace at block 2512. The listing may include an original price of the base value type based on the original pricing indicator and an alternate price of an alternate value type. The original price may have a different value than the alternate price. The posting of the listing for the item in the network-based marketplace may include the description.

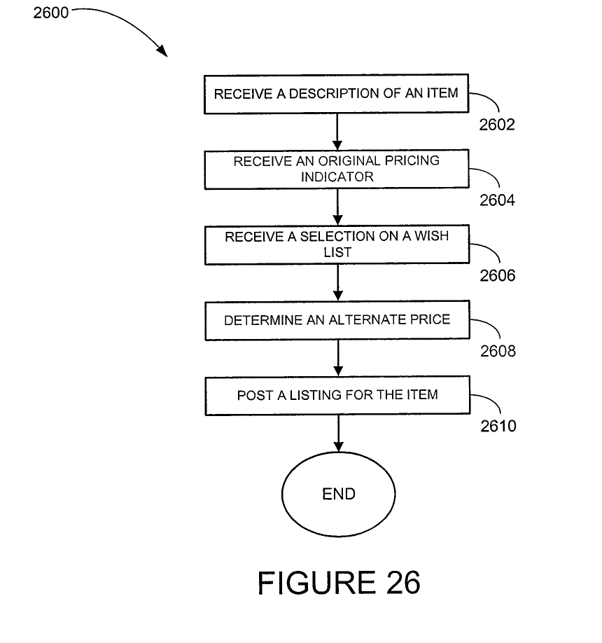

FIG. 26 illustrates a method 2600 for item listing according to an example embodiment. The method 2600 may be performed by the client machine 102 and/or the marketplace provider 124 of the system 100 (see FIG. 1) or otherwise performed.

The method 2600 may be used to receive a price for an item in a first currency type, receive a selection on a wish list, set an alternate price for the item based on the selection, and post a listing including both the first currency type and the second currency type. The value of the first currency type and the second currency type may not be equal.

A description of an item may be received at block 2602. An original pricing indicator of a base value type for an item is received at block 2604.

A selection may be received on a wish list at block 2606. The selection may be received from the user of the client machine 102. An alternate price may be determined for the selection at block 2608. The selection may indicate a different item which the user desires which may be purchased using an alternate price. For example, the selection may be a first class ticket to Europe that costs either $11,985.50 in US Dollars or 125,000 MILEAGE PLUS frequent flyer miles issued by UNITED AIRLINES as the virtual value provider 108. The alternate price may then be the 125,000 frequent flyer miles.

A listing for the item is posted in a network-based marketplace at block 2610. The listing may include an original price of the base value type based on the original pricing indicator and an alternate price of an alternate value type. The original price may have a different value than the alternate price. The posting of the listing for the item in the network-based marketplace may include the description.

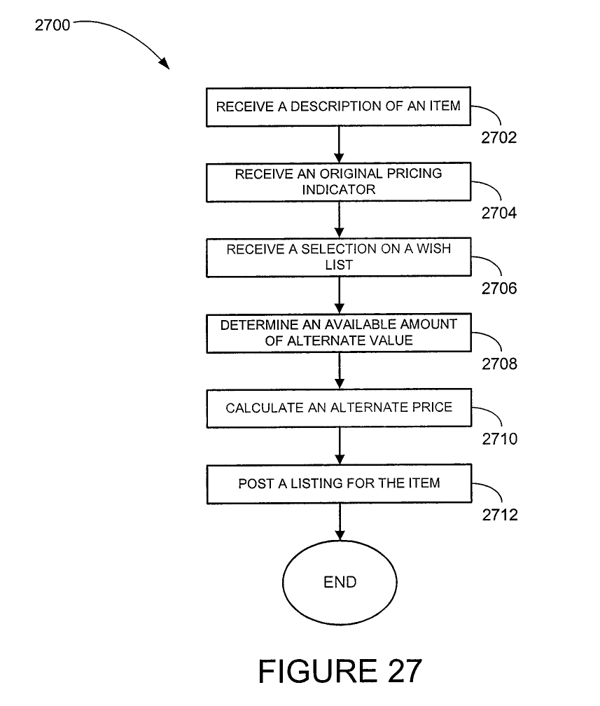

FIG. 27 illustrates a method 2700 for item listing according to an example embodiment. The method 2700 may be performed by the client machine 102 and/or the marketplace provider 124 of the system 100 (see FIG. 1) or otherwise performed.

The method 2600 may be used to receive a price for an item in a first currency type, receive a selection on a wish list, set an alternate price for the item based on the selection and an available amount of alternate value available to the user, and post a listing including both the first currency type and the second currency type. The value of the first currency type and the second currency type may not be equal.

A description of an item may be received at block 2702. An original pricing indicator of a base value type for an item is received at block 2704.

A selection on a wish list may be received at block 2706. An available amount of alternate value may be determined at block 2708. The alternate value may be available from the payment processor 106, the virtual value provider 108, or may be otherwise available.

At block 2710, the alternate price may be calculated based on an additional amount of the alternate value needed for the selection. The additional amount may be the difference between the amount of the selection and the available amount of alternate value available to the user. For example, if a first class ticket to Europe costs 125,000 BA Miles, frequent flyer miles issued by virtual value provider 108 BRITISH AIRWAYS, and the user already has 60,000 BA MILES, then the alternate price may be 65,000 BA MILES. Such an alternative price offered through the marketplace provider 124 may be priced at a fixed 65,000 BA MILES or as a reserve price to enable users to bid a larger amount of BA MILES.

All forms of virtual values may not be equivalent. For example, a user that had more than 65,000 FLYING BLUE miles, issued by KLM ROYAL DUTCH AIRLINES as the virtual value provider 108, may not be able to purchase the item without first converting the FLYING BLUE miles into BA MILES, using one or more of the embodiments described above.

A listing for the item is posted in a network-based marketplace at block 2712. The listing may include an original price of the base value type based on the original pricing indicator and an alternate price of an alternate value type. The original price may have a different value than the alternate price. The posting of the listing for the item in the network-based marketplace may include the description.

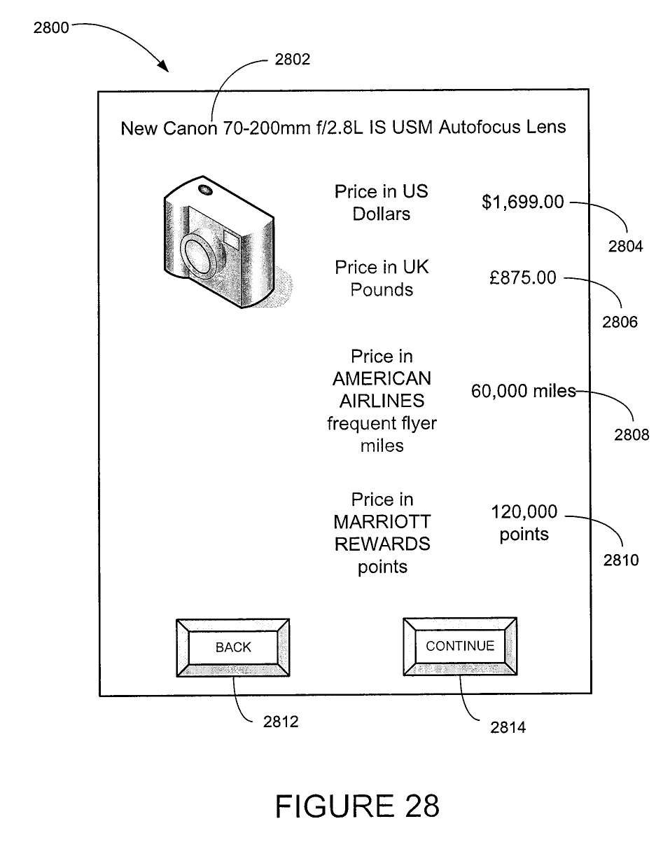

FIG. 28 is an example diagram of a user interface 2800 according to an example embodiment. The user interface 2800 may be presented to a user of the client machine 102 or otherwise provided. The user interface 2800 may, by way of example, be presented to a user based on the operations performed at block 2310, block 2410, block 2512, block 2610, and/or block 2712. The user interface 2800 may be otherwise presented.

The user interface may present an item 2802 (e.g., a good or a service) available for purchase. The item may have multiple real prices and/or virtual prices 2804-2810.

The item 2802 include in FIG. 28 has a US real value price 2804 of $1,699.00, a UK real value price 2806 of £875.00, an AMERICAN AIRLINES virtual value price 2808 of 60,000 AADVANTAGE miles, and a MARRIOTT virtual value price 2810 of 120,000 MARRIOTT REWARDS points.

The prices 2804-2810 may have different values. By way of an example, if the base price is the US real price 2804, the UK real price when converted to US dollars at a set conversion rate may be equivalent to only $1,610.75. However, the merchant or seller may accept the lesser value of the UK real price 2806 and use the money to make purchases while in the UK. The AMERICAN AIRLINES AADVANTAGE virtual value price 2808 and the MARRIOTT REWARDS virtual value price 2810 may also have a different value than the US real price 2084. For example, the 60,000 AADVANTAGE frequent flyer miles may be earned or may be purchased from the virtual value provider 108 AMERICAN AIRLINES at a cost $1,530. However, the merchant and seller may accept the AMERICAN AIRLINES virtual value price 2808 to purchase a business class ticket to Cancun, Mexico that might otherwise cost $1,900.

The user may select a back button 2812 to return to a previous screen. The user may select a continue button 2814 to proceed with a purchase of the item.

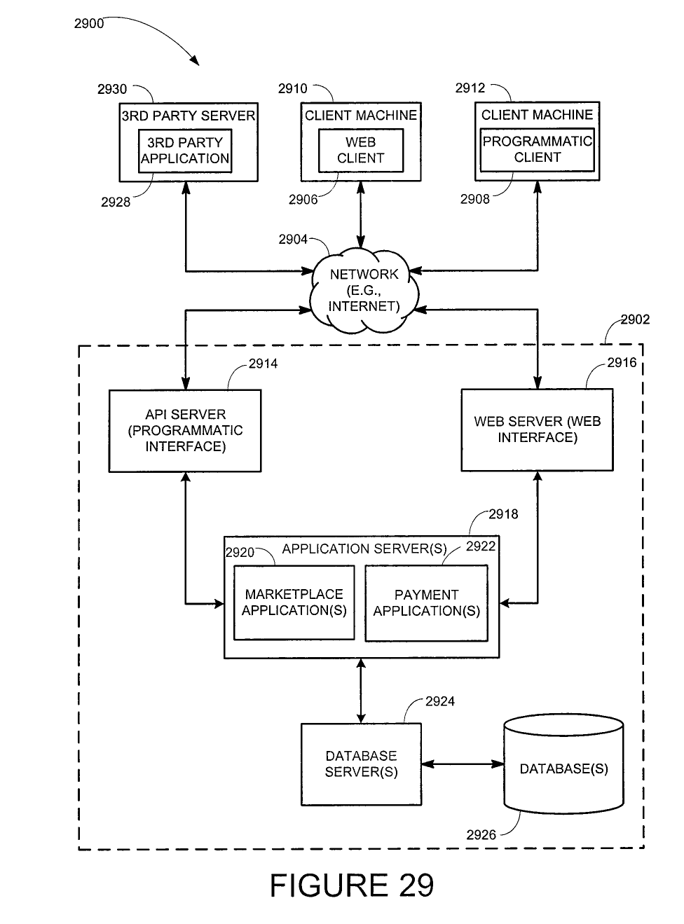

FIG. 29 is a network diagram depicting a client-server system 2900, within which an example embodiment may be deployed. By way of example, a network 2904 may include the functionality of the network 104, the payment processor 106, the virtual value provider 108, and/or the marketplace provider 124 may be deployed within an application server 2918, and the client machine 102 may include the functionality of a client machine 2910 or a client machine 2912 (see FIG. 1). The payment applications 2922 may include the functionality of the payment processor 106. The marketplace applications 2920 may include the functionality of the marketplace provider 124. The system 100 may also be deployed in other systems.

A networked system 2902, in the example forms of a network-based marketplace or publication system, provides server-side functionality, via a network 2904 (e.g., the Internet or Wide Area Network (WAN)) to one or more clients. FIG. 29 illustrates, for example, a web client 2906 (e.g., a browser, such as the INTERNET EXPLORER browser developed by Microsoft Corporation of Redmond, Wash.; or such as SAFARI, the internet browser developed by Apple, Inc, of Cupertino, Calif.; or such as CHROME, the internet browser developed by Google of Mountain View, Calif.), and a programmatic client 2908 executing on respective client machines 2910 and 2912.

An Application Program Interface (API) server 2914 and a web server 2916 are coupled to, and provide programmatic and web interfaces respectively to, one or more application servers 2918. The application servers 2918 host one or more marketplace applications 2920 and authentication providers 2922. The application servers 2918 are, in turn, shown to be coupled to one or more databases servers 2924 that facilitate access to one or more databases 2926.

The marketplace applications 2920 may provide a number of marketplace functions and services to users that access the networked system 2902. The authentication providers 2922 may likewise provide a number of payment services and functions to users. The authentication providers 2922 may allow users to accumulate value (e.g., in a real value currency, such as the U.S. dollar, or a proprietary virtual value currency, such as “points”, “frequent flier miles”, and/or other virtual values) in accounts, and then later to redeem the accumulated value for products (e.g., goods or services) that are made available via the marketplace applications 2920. While the marketplace and authentication providers 2920 and 2922 are shown in FIG. 29 to both form part of the networked system 2902, in alternative embodiments the authentication providers 2922 may form part of a payment service that is separate and distinct from the networked system 2902.

Further, while the system 2900 shown in FIG. 29 employs a client-server architecture, embodiments of the present invention are of course not limited to such an architecture, and could equally well find application in a distributed, or peer-to-peer, architecture system, for example. The various marketplace and authentication providers 2920 and 2922 could also be implemented as standalone software programs, which need not have networking capabilities.

The web client 2906 accesses the various marketplace and authentication providers 2920 and 2922 via the web interface supported by the web server 2916. Similarly, the programmatic client 2908 accesses the various services and functions provided by the marketplace and authentication providers 2920 and 2922 via the programmatic interface provided by the API server 2914. The programmatic client 2908 may, for example, be a seller application (e.g., the TurboLister™ application developed by eBay Inc., of San Jose, Calif.) to enable sellers to author and manage listings on the networked system 2902 in an off-line manner, and to perform batch-mode communications between the programmatic client 2908 and the networked system 2902.

FIG. 29 also illustrates a third party application 2928, executing on a third party server machine 2930, as having programmatic access to the networked system 2902 via the programmatic interface provided by the API server 2914. For example, the third party application 2928 may, utilizing information retrieved from the networked system 2902, support one or more features or functions on a website hosted by the third party. The third party may, for example, provide one or more promotional, marketplace or payment functions that are supported by the relevant applications of the networked system 2902.

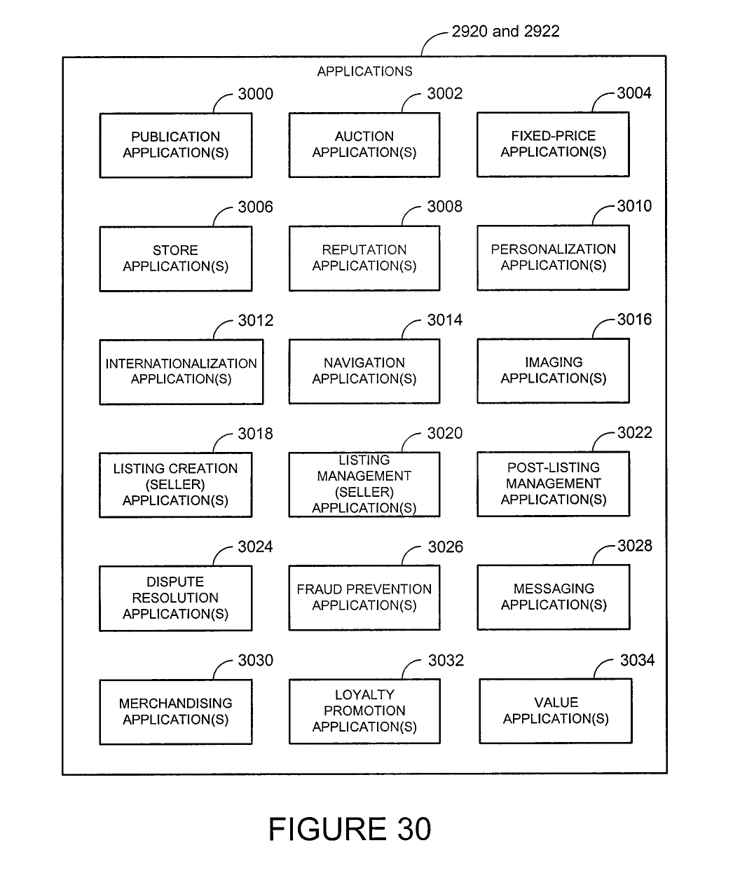

FIG. 30 is a block diagram illustrating multiple applications 2920 and 2922 that, in one example embodiment, are provided as part of the networked system 2902 (see FIG. 29). The applications 2920 may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access one or more databases 2926 via the database servers 2924.

The networked system 2902 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. The price for such goods and services may be listed in one or more real or virtual values, to meet the objectives of the sellers and buyers of the marketplace applications 2920. To this end, the marketplace applications 2920 are shown to include at least one publication application 3000 and one or more auction applications 3002 which support auction-format listing and price setting mechanisms (e.g., English, Dutch, Vickrey, Chinese, Double, Reverse auctions etc.). The various auction applications 3002 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 3004 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 3006 allow a seller to group listings within a “virtual” store, which may be branded and otherwise personalized by and for the seller. Such a virtual store may also offer promotions, incentives and features that are specific and personalized to a relevant seller.

Reputation applications 3008 allow users that transact, utilizing the networked system 2902, to establish, build and maintain reputations, which may be made available and published to potential trading partners. Consider that where, for example, the networked system 2902 supports person-to-person trading, users may otherwise have no history or other reference information whereby the trustworthiness and credibility of potential trading partners may be assessed. The reputation applications 3008 allow a user, for example through feedback provided by other transaction partners, to establish a reputation within the networked system 2902 over time. Other potential trading partners may then reference such a reputation for the purposes of assessing credibility and trustworthiness.

Personalization applications 3010 allow users of the networked system 2902 to personalize various aspects of their interactions with the networked system 2902. For example a user may, utilizing an appropriate personalization application 3010, create a personalized reference page at which information regarding transactions to which the user is (or has been) a party may be viewed. Further, a personalization application 3010 may enable a user to personalize listings and other aspects of their interactions with the networked system 2902 and other parties.

The networked system 2902 may support a number of marketplaces that are customized, for example, for specific geographic regions. A version of the networked system 2902 may be customized for the United Kingdom, whereas another version of the networked system 2902 may be customized for the United States. Each of these versions may operate as an independent marketplace, or may be customized (or internationalized and/or localized) presentations of a common underlying marketplace. The networked system 2902 may accordingly include a number of internationalization applications 3012 that customize information (and/or the presentation of information) by the networked system 2902 according to predetermined criteria (e.g., geographic, demographic or marketplace criteria). For example, the internationalization applications 3012 may be used to support the customization of information for a number of regional websites that are operated by the networked system 2902 and that are accessible via respective web servers 2916.

Navigation of the networked system 2902 may be facilitated by one or more navigation applications 3014. For example, a search application (as an example of a navigation application) may enable key word searches of listings published via the networked system 2902. A browse application may allow users to browse various category, catalogue, or system inventory structures according to which listings may be classified within the networked system 2902. Various other navigation applications may be provided to supplement the search and browsing applications.

In order to make listings available via the networked system 2902 as visually informing and attractive as possible, the marketplace applications 2920 may include one or more imaging applications 3016 utilizing which users may upload images for inclusion within listings. An imaging application 3016 also operates to incorporate images within viewed listings. The imaging applications 3016 may also support one or more promotional features, such as image galleries that are presented to potential buyers. For example, sellers may pay an additional fee to have an image included within a gallery of images for promoted items.

Listing creation applications 3018 allow sellers conveniently to author listings pertaining to goods or services that they wish to transact via the networked system 2902, and listing management applications 3020 allow sellers to manage such listings. Specifically, where a particular seller has authored and/or published a large number of listings, the management of such listings may present a challenge. The listing management applications 3020 provide a number of features (e.g., auto-relisting, inventory level monitors, etc.) to assist the seller in managing such listings. One or more post-listing management applications 3022 also assist sellers with a number of activities that typically occur post-listing. For example, upon completion of an auction facilitated by one or more auction applications 2922, a seller may wish to leave feedback regarding a particular buyer. To this end, a post-listing management application 3022 may provide an interface to one or more reputation applications 3008, so as to allow the seller conveniently to provide feedback regarding multiple buyers to the reputation applications 3008.

Dispute resolution applications 3024 provide mechanisms whereby disputes arising between transacting parties may be resolved. For example, the dispute resolution applications 3024 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention applications 3026 implement fraud detection and prevention mechanisms to reduce the occurrence of fraud within the networked system 2902.

Messaging applications 3028 are responsible for the generation and delivery of messages to users of the networked system 2902, such messages for example advising users regarding the status of listings at the networked system 2902 (e.g., providing “outbid” notices to bidders during an auction process or to provide promotional and merchandising information to users). Respective messaging applications 3028 may utilize any one having a number of message delivery networks and platforms to deliver messages to users. For example, messaging applications 3028 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 3030 support various merchandising functions that are made available to sellers to enable sellers to increase sales via the networked system 2902. The merchandising applications 3030 also operate the various merchandising features that may be invoked by sellers, and may monitor and track the success of merchandising strategies employed by sellers.

The networked system 2902 itself, or one or more parties that transact via the networked system 2902, may operate loyalty programs that are supported by one or more loyalty/promotions applications 3032. For example, a buyer may earn loyalty or promotions points for each transaction established and/or concluded with a particular seller, and may be offered a reward for which accumulated loyalty points can be redeemed.

One or more value applications 3034 may support usage of one or more value types (e.g., currencies) including real value and/or virtual value. For example, the value applications 3034 may enable listings created by the listing creation applications 3018 to include one or more real value or currency types for payment acceptance and/or to accept one or more types of virtual value, and/or a combination of real and virtual value, as a form of payment. The value applications 3034 may support the publication applications 3000, the auction applications 3002, and the fixed-price applications 3004 to accept multiple value types for payment acceptance and/or to accept virtual value as a form of payment. The value applications 3034 may be used otherwise.

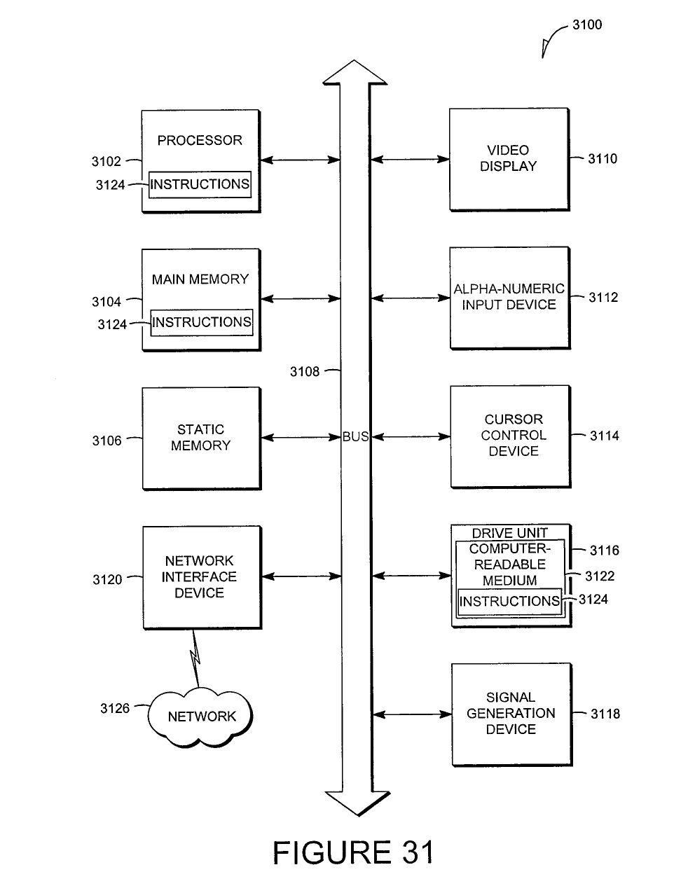

FIG. 31 shows a block diagram of a machine in the example form of a computer system 3100 within which a set of instructions may be executed causing the machine to perform any one or more of the methods, processes, operations, or methodologies discussed herein. The payment processor 106, the virtual value provider 108, the conversion rate provider 120, the value receiver 122, and/or the marketplace provider 124 may operate on one or more computer systems 3100. The client machine 102 may include the functionality of the one or more computer systems 3100.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, a kiosk, a point of sale (POS) device, a cash register, an Automated Teller Machine (ATM), or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 3100 includes a processor 3102 (e.g., a central processing unit (CPU) a graphics processing unit (GPU) or both), a main memory 3104 and a static memory 3106, which communicate with each other via a bus 3108. The computer system 3100 may further include a video display unit 3110 (e.g., a liquid crystal display (LCD) or a cathode ray tube (CRT)). The computer system 3100 also includes an alphanumeric input device 3112 (e.g., a keyboard), a cursor control device 3114 (e.g., a mouse), a drive unit 3116, a signal generation device 3118 (e.g., a speaker) and a network interface device 3120.

The drive unit 3116 includes a machine-readable medium 3122 on which is stored one or more sets of instructions (e.g., software 3124) embodying any one or more of the methodologies or functions described herein. The software 3124 may also reside, completely or at least partially, within the main memory 3104 and/or within the processor 3102 during execution thereof by the computer system 3100, the main memory 3104 and the processor 3102 also constituting machine-readable media.

The software 3124 may further be transmitted or received over a network 3126 via the network interface device 3120.

While the machine-readable medium 3122 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules may be implemented as hardware circuitry, optical components, single or multi-processor circuits, memory circuits, software program modules and objects, firmware, and combinations thereof, as appropriate for particular implementations of various embodiments.

In an example embodiment, a virtual value indication associated with a user may be received from a virtual value provider. The virtual value indication may be associated with virtual value in an account of the user. A payment request may be received. A portion of the virtual value associated with the account may be converted to a base value of a base value type at a conversion rate in response to the receiving of the payment request. The payment request may be processed for the account using the base value.

In an example embodiment, a virtual value usage request associated with a user may be received. The virtual value usage request may include a virtual value amount of a virtual value type. A virtual value processing request may be provided to a virtual value provider. A conversion rate may be accessed for the virtual value type. Value in a settlement account of the virtual value provider may be altered based on the virtual value amount and the conversion rate.

In an example embodiment, a virtual value payment processing request may be received from a payment processor. The virtual value payment processing request may include a virtual value amount and an account identifier. A user account may be identified based on the account identifier. Verification that the user account has virtual value in the virtual value amount may be performed. A value confirmation may be provided to the payment processor based on the verification that the user account has virtual value in the virtual value amount. The virtual value in the user account may be altered by the virtual value amount.

In an example embodiment, a payment request associated with a user account may be received. A determination of whether virtual value is available to the user account may be performed. A portion of the virtual value may be converted to a base value of a base value type at a conversion rate in response to the determining. The payment request may be processed for the account using the base value.

In an example embodiment, a virtual value payment request may be received for a source user account. The virtual value payment request may include a payment amount. Virtual value associated with the source user account may be altered based on the payment amount. The virtual value associated with a target user account may be altered based on the payment amount.

In an example embodiment, an original pricing indicator of a base value type for the item may be received. A listing for the item may be posted in a network-based marketplace. The listing may include an original price of the base value type based on the original pricing indicator and an alternate price of an alternate value type. The original price may have a different value than the alternate price.

Thus, methods and systems for payments with virtual value have been described. Although embodiments of the present invention have been described with reference to specific example embodiments, it will be evident that various modifications and changes may be made to these embodiments without departing from the broader spirit and scope of the embodiments of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
receiving a virtual value indication associated with a user from a virtual value provider;
associating virtual value with an account of the user in response to the receiving of the virtual value indication;
receiving a payment request;
converting a portion of the virtual value associated with the account to a base value of a base value type at a conversion rate in response to the receiving of the payment request; and
processing the payment request for the account using the base value.

2. The method of claim 1, wherein the converting of the portion comprises:
accessing the conversion rate;
updating the conversion rate to obtain an updated conversion rate; and
converting the portion of the virtual value associated with the account to the base value of the base value type at the updated conversion rate in response to the receiving of the payment request.

3. The method of claim 1, wherein the converting of the portion comprises:
determining whether a conversion criterion is met in response to the receiving of the payment request;
setting the conversion rate based on a result of the determining of whether the user meets the conversion criterion; and
converting the portion of the virtual value associated with the account to the base value of the base value type at the conversion rate in response to the setting of the conversion rate.

4. The method of claim 3, wherein the conversion criterion is based on a virtual value threshold, a program entry date of the user, an amount of the payment request, an item associated with the payment request, or combinations thereof.

5. The method of claim 1, further comprising:
providing a notification regarding availability to use the portion of the virtual value to fulfill the payment request.

6. The method of claim 1, further comprising:
providing funding source data identifying a plurality of value types having value in the account of the user.

7. The method of claim 6, further comprising:
receiving a value type selection of a virtual value type of the plurality of value types; and
wherein the converting of the portion is in response to the to the receiving of the payment request and the value type selection.

8. The method of claim 7, further comprising:
receiving an additional value type selection of a particular value type of the plurality of value types; and
wherein the converting of the portion is in response to the receiving of the payment request, the value type selection, and the additional value type selection.

9. The method of claim 6, wherein the providing of the funding source data comprises:
providing the funding source data identifying the plurality of value types having the value in the account of the user and the value of each of the plurality of value types.

10. The method of claim 1, further comprising:
determining whether the payment request meets a compliance criterion associated with the virtual value provider; and
wherein the converting of the portion is based on a determination that the payment request meets the compliance criterion and is in response to the receiving of the payment request.

11. The method of claim 1, further comprising:
generating a converted value report based on the converting of the portion.

12. The method of claim 11, wherein the generating of the converted value report is further based on an item value of an item associated with the payment request, a virtual value purchase cost, item historical value exchange data for the item, or combinations thereof.

13. The method of claim 1, wherein the virtual value provider is an airline reward program, a hotel reward program, a rental car reward program, a travel reward program, or combinations thereof.

14. A method comprising:
receiving a virtual value usage request associated with a user, the virtual value usage request including a virtual value amount of a virtual value type;
providing a virtual value processing request to a virtual value provider;
accessing a conversion rate for the virtual value type; and
altering value in a settlement account of the virtual value provider based on the virtual value amount and the conversion rate.

15. The method of claim 14, further comprising:
receiving value confirmation from the virtual value provider; and
wherein the altering of the value in the settlement account is in response to the receiving of the value confirmation.

16. The method of claim 14, further comprising:
determining whether virtual value usage is available for the user; and
wherein the providing of the virtual value processing request is based on a determination that the virtual value usage is available for the user.

17. The method of claim 14, further comprising:
altering the value in a user account associated with the user based on the virtual value amount and the conversion rate.

18. The method of claim 14, further comprising:
altering the value in a value receiver account associated with a value receiver based on the virtual value amount and the conversion rate, the value receiver being identified in the virtual value usage request.

19. The method of claim 14, wherein the virtual value usage request is a virtual value payment request and the virtual value processing request is a virtual value payment processing request.

20. The method of claim 14, wherein the virtual value usage request is a virtual value borrow request and the virtual value processing request is a virtual value credit processing request.

21. A method comprising:
receiving a virtual value payment processing request from a payment processor, the virtual value payment processing request including a virtual value amount and an account identifier;
identifying a user account based on the account identifier;
verifying that the user account has virtual value in the virtual value amount;
providing a value confirmation to the payment processor based on a verification that the user account has virtual value in the virtual value amount; and
altering the virtual value in the user account by the virtual value amount.

22. The method of claim 21, further comprising:
establishing a compliance criterion for the virtual value payment processing request;
determining whether the compliance criterion is met for the virtual value payment processing request; and
wherein the altering of the virtual value is based on a determination that the compliance criterion is met.

23. The method of claim 21, wherein the virtual value includes a travel reward point, a frequent flyer mile, a hotel reward point, a rental car point, or combinations thereof.

24. The method of claim 21, wherein the virtual value includes quantities of gold, silver, oil, or combinations thereof.

25. A method comprising:
receiving a payment request associated with a user account;
determining whether virtual value is available to the user account;
converting a portion of the virtual value to a base value of a base value type at a conversion rate in response to the determining; and
processing the payment request for the account using the base value.

26. The method of claim 25, further comprising:
receiving virtual value associated with the user from a virtual value provider; and
associating the virtual value with the user account.

27. The method of claim 25, further comprising:
providing a notification regarding the availability of the virtual value to the user account; and
receiving a payment response to the notification,
wherein the converting of the portion is based on the receiving of the payment response.

28. The method of claim 25, further comprising:
providing a compliance request to a virtual value provider, the virtual value provider being capable of determining whether the payment request meets a compliance criterion associated with the virtual value provider;
receiving a compliance authorization from the virtual value provider in response to the providing of the compliance request; and
wherein the converting of the portion and the processing of the payment is based on the receiving of the compliance authorization.

29. A method comprising:
receiving a virtual value payment request for a source user account, the virtual value payment request including a payment amount; and
altering virtual value associated with the source user account based on the payment amount; and
altering the virtual value associated with a target user account based on the payment amount.

30. The method of claim 29, further comprising:
altering the virtual value associated with a payment processor account based on the payment amount.

31. The method of claim 29, further comprising:
accessing a conversion rate for the virtual value based on a virtual value type of the virtual value; and
altering a settlement account of the target user based on the payment amount and the conversion rate.

32. The method of claim 29, further comprising:
notifying a virtual value provider of the altering of the virtual value associated with the target user account, the virtual value provider being capable of tracking a total account value association for the target user account.

33. The method of claim 29, further comprising:
determining whether the virtual value payment quest meets a compliance criterion associated with a virtual value provider,
wherein the altering of the virtual value is based on a determination that the payment request meets the compliance criterion.

34. The method of claim 33, wherein the compliance criterion includes a funding source rule, a balance rule, a virtual value transferability rule, a payment processor rule, or combinations thereof.

35. The method of claim 29, further comprising:
providing a compliance request to a virtual value provider, the virtual value provider being capable of determining whether the virtual value payment request meets a compliance criterion associated with the virtual value provider; and
receiving a compliance authentication from the virtual value provider in response to the providing of the compliance request,
wherein the altering of the virtual value is based on the receiving of the compliance authentication.

36. The method of claim 29, further comprising:
receiving identification of the target user account,
wherein the altering of the virtual value associated with the target user account is based on the payment amount and in response to the receiving of the identification.

37. The method of claim 29, further comprising:
tracking the altering of the virtual value associated with at least one of the source user account, the target user account, or combinations thereof.

38. The method of claim 37, further comprising:
receiving an additional virtual value payment request for the source user account, the additional virtual value payment request including an additional payment amount;
determining whether the source user account may be altered by the additional payment amount based on the tracking of the source user account; and
based on a result of the determining, altering the virtual value associated with the source user account.

39. A method comprising:
receiving an original pricing indicator of a base value type for an item; and
posting a listing for the item in a network-based marketplace, the listing including an original price of the base value type based on the original pricing indicator and an alternate price of an alternate value type,
wherein the original price has a different value than the alternate price.

40. The method of claim 39, further comprising:
receiving a description of the item,
wherein the posting of the listing for the item in the network-based marketplace includes the original price of the base value type based on the original pricing indicator, the alternate price of an alternate value type, and the description.

41. The method of claim 39, further comprising:
receiving an alternate pricing indicator of the alternate value type for the item,
wherein the posting a listing for the item in a network-based marketplace is in response to the receiving of the alternate pricing indicator.

42. The method of claim 41, further comprising:
adjusting the alternate pricing indicator by a marketplace fee to obtain the alternate price.

43. The method of claim 41, wherein the alternate pricing indicator includes the alternate price.

44. The method of claim 39, further comprising:
accessing a value adjustment for the alternate value type;
calculating the alternate price based on the original price and the value adjustment; and
wherein the posting of the listing for the item in the network-based marketplace occurs after the calculating of the alternate price.

45. The method of claim 39, further comprising:
providing a conversion rate from the base value type to the alternate value type;
receiving a rate adjustment for the conversion rate;
adjusting the original price using the conversion rate and the rate adjustment to set the alternate price; and
wherein the posting of the listing for the item in the network-based marketplace occurs after the adjusting of the original price.

46. The method of claim 39, further comprising:
receiving a selection on a wish list;
determining the alternate price for the selection; and
wherein the posting of the listing for the item in the network-based marketplace occurs after the determining of the alternate price.

47. The method of claim 39, further comprising:
receiving a selection on a wish list; and
determining an available amount of alternate value;
calculating the alternate price based on an additional amount of the alternate value needed for the selection; and
wherein the posting of the listing for the item in the network-based marketplace occurs after the calculating of the alternate price.

48. The method of claim 39, wherein the original pricing indicator includes the original price.

49. The method of claim 39, wherein the original price includes real value and the alternate value includes virtual value.

50. A machine-readable medium comprising instructions, which when executed by one or more processors, cause the one or more processors to perform the following operations:
receive a virtual value indication associated with a user from a virtual value provider;
associate virtual value with an account of the user in response to receiving the virtual value indication;
receive a payment request;
convert a portion of the virtual value associated with the account to a base value of a base value type at a conversion rate in response to receipt of the payment request; and
process the payment request for the account using the base value.

51. The machine-readable medium of claim 50 further comprising instructions, which when implemented by one or more processors perform the following operations:
determine whether the payment request meets a compliance criterion associated with the virtual value provider; and
wherein converting of the portion is based on a determination that the payment request meets the compliance criterion and in response to receiving the payment request.

52. A machine-readable medium comprising instructions, which when executed by one or more processors, cause the one or more processors to perform the following operations:
receive a virtual value usage request associated with a user, the virtual value usage request including a virtual value amount of a virtual value type;
provide a virtual value processing request to a virtual value provider;
access a conversion rate for the virtual value type; and
alter value in a settlement account of the virtual value provider based on the virtual value amount and the conversion rate.

53. The machine-readable medium of claim 52 further comprising instructions, which when implemented by one or more processors perform the following operations:
receive value confirmation from the virtual value provider; and
wherein altering of the value in the settlement account is in response to receiving the value confirmation.

54. A machine-readable medium comprising instructions, which when executed by one or more processors, cause the one or more processors to perform the following operations:
receive a virtual value payment processing request from a payment processor, the virtual value payment processing request including a virtual value amount and an account identifier;
identify a user account based on the account identifier;
verify that the user account has virtual value in the virtual value amount;
provide a value confirmation to the payment processor based on a verification that the user account has virtual value in the virtual value amount; and
alter the virtual value in the user account by the virtual value amount.

55. The machine-readable medium of claim 54 further comprising instructions, which when implemented by one or more processors perform the following operations:
establish a compliance criterion for the virtual value payment processing request;
determine whether the compliance criterion is met for the virtual value payment processing request; and
wherein alteration of the virtual value is based on a determination that the compliance criterion is met.

56. A machine-readable medium comprising instructions, which when executed by one or more processors, cause the one or more processors to perform the following operations:
receive a payment request associated with a user account;
determine whether virtual value is available to the user account;
convert a portion of the virtual value to a base value of a base value type at a conversion rate in response to a determination of whether the virtual value is available; and
process the payment request for the account using the base value.

57. The machine-readable medium of claim 56 further comprising instructions, which when implemented by one or more processors perform the following operations:
receive virtual value associated with the user from a virtual value provider; and
associate the virtual value with the user account.

58. A machine-readable medium comprising instructions, which when executed by one or more processors, cause the one or more processors to perform the following operations:
receive a virtual value payment request for a source user account, the virtual value payment request including a payment amount; and
alter virtual value associated with the source user account based on the payment amount; and
alter the virtual value associated with a target user account based on the payment amount.

59. The machine-readable medium of claim 58 further comprising instructions, which when implemented by one or more processors perform the following operations:
receive virtual value based on a virtual value type of the virtual value with the user account.

60. A machine-readable medium comprising instructions, which when executed by one or more processors, cause the one or more processors to perform the following operations:
receive an original pricing indicator of a base value type for an item; and
post a listing for the item in a network-based marketplace, the listing including an original price of the base value type based on the original pricing indicator and an alternate price of an alternate value type,
wherein the original price has a different value than the alternate price.

61. The machine-readable medium of claim 60 further comprising instructions, which when implemented by one or more processors perform the following operations:
receive an alternate pricing indicator of the alternate value type for the item; and
wherein the listing includes the alternate price of the alternate value type based on the alternate pricing indicator.

62. A system comprising:
a virtual value indication receiver module to receive a virtual value indication associated with a user from a virtual value provider;
a virtual value association module to associate virtual value with an account of the user based on receipt of the virtual value indication by the virtual value indication receiver module;
a request receiver module to receive a payment request;
a virtual value conversion module to convert a portion of the virtual value associated with the account by the virtual value association module to a base value of a base value type at a conversion rate in response to the receiving of the payment request by the request receiver module; and
a request processing module to process the payment request received by the request receiver module for the account using the base value.

63. The system of claim 62, further comprising:
an availability determination module to determine whether virtual value is available; and
wherein the conversion of the portion of the virtual value by the virtual value conversion module is based on availability of the virtual value determined by the availability determination module.
